(19) United States
(12) Patent Application Publication
(10) Pub. No.: US 2025/0120413 A1
(43) Pub. Date: Apr. 17, 2025

(54) ALTERNATIVE COFFEE BEVERAGES

(71) Applicant: Compound Foods Inc., San Francisco, CA (US)

(72) Inventors: Vijayalakshmi GANESH, San Francisco, CA (US); María José DURÁN GONZÁLEZ, San Francisco, CA (US); Alessandra MOLINA, San Francisco, CA (US); Maricel SAENZ, San Francisco, CA (US); Andrew M. SHUMAKER, San Francisco, CA (US); Matthew D. YOUNGBLUT, San Francisco, CA (US); Swetha MAHADEVAN, San Francisco, CA (US)

(21) Appl. No.: 18/687,291

(22) PCT Filed: Aug. 29, 2022
(86) PCT No.: PCT/US2022/075582

§ 371 Date: Feb. 27, 2024

Related U.S. Application Data
(60) Provisional application No. 63/260,683, filed on Aug. 27, 2021.

(51) Int. Cl. A23F 5/44; A23L 2/38; A23L 2/56; A23L 2/68

(52) U.S. Cl. CPC A23F 5/44; A23L 2/382; A23L 2/56; A23L 2/68

(57) ABSTRACT

Coffee-like beverage compositions and methods of forming and using them that include an unfermented plant-based mixture combined with a fermented substrate and optionally one or more flavor additives.

### CLAIM OF PRIORITY

This patent application claims priority to U.S. provisional patent application no. 63/260,683, titled “Alternative Coffee Beverages” filed on Aug. 27, 2022, and herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### BACKGROUND

Coffee is typically brewed from roasted and ground seeds of the Coffea plant and is one of the most highly consumed products worldwide, with daily consumption of about 2.25 billion cups.

Coffee is produced by harvesting the fruits of Coffea arabica or Coffea canephora. The fruit is then sent for processing where the seed is separated from the fruit during a step that involves washing, depulping under pressure or fermentation; drying the seeds in shade or the sun, and removing the husks. The resulting dry, green seeds (green coffee beans) are typically stored and shipped from the coffee producing countries throughout the world to be roasted, imparting a characteristic set of flavors and dark colors. These roasted seeds, better known as whole coffee beans, are ready for grinding and brewing.

The high global demand for coffee imposes significant negative externalities on the environment and on coffee-producing countries. Most coffee plantations may only exist in a narrow geographical band proximal to the global equator, known as the coffee belt. Countries occupying these geographies are incentivized to clear rainforests for the development of coffee plantations; 37 of the 50 countries with the highest deforestation rates in the world are coffee-producing countries. Coffee growth, processing, and transportation entail high water and carbon usage: 140 liters of water are needed to produce 1 cup of coffee, and 1 kg of coffee creates 17 kg of CO2 equivalents.

Despite the pollutive and unsustainable nature of the coffee industry, alternatives and substitutes have not been widely adopted. This is due in part to the unique flavor characteristics of brewed coffee, which are attributable to three groups of chemical compounds: i) compounds produced by the Coffea plant; ii) compounds produced during processing steps that involve fermentation; and iii) compounds produced during roasting. Compounds produced by the Coffea plant include alkaloids such as caffeine and theobromine, which have flavors and psychoactive properties and which are found relatively rarely in Nature. Compounds produced during processing steps that involve fermentation include organic acids, pyrazines, furans, and other metabolites. Compounds produced during roasting include melanoidins, which are brown-colored compounds formed by molecular transformations such as combinations of amino acids and sugars, among other molecules. As our understanding of the molecular transformations inherent to coffee production increases, so does our ability to recreate the final product in a way that does not require the same pollutive and wasteful inputs and processes.

It would be highly beneficial to provide compositions, including coffee alternatives, and methods of making and packing such coffee alternatives.

### SUMMARY OF THE DISCLOSURE

These methods and compositions may relate to beverages that taste and smell like brewed coffee, but which does not require growth, harvest, processing, and roasting of coffee beans. These methods and compositions are based on identification of key flavor components of brewed coffee and the identification of alternative sources of those flavor components in more sustainable sources.

Accordingly, described herein are base formulas of one or more plant-derived ingredients; brewing said base formulas with hot water and/or cold water will produce a brewed coffee substitute beverage with flavor properties similar to brewed coffee. Also identified herein are particular plant-derived ingredients that increase the resulting brewed coffee substitute beverage's similarity to brewed coffee. Some iterations of said base formulas yielded brewed coffee substitute beverages that were rated by taste testers as 70%, 75%, and 80% similar to brewed coffee.

In some examples, some aspects of brewed coffee were not replicated in the brewed coffee substitute beverage by modifications to the base formula of plant-derived ingredients alone. For instance, inventors found in brewed coffee a richness, depth, complexity, acidity, and fruitiness that were lacking in the brewed coffee substitute beverage. Accordingly, also described herein are fermentation substrates that include one or more microbes. In particular, described herein are methods and compositions that include microbes and facilitate fermentative processes compatible with the aforementioned base formulas of plant-derived ingredients. Described herein are methods and compositions that adapt fermentative processes observed in coffee production to the production of the brewed coffee substitute beverage, using one or a variety of prokaryotic (e.g. Lactobacillus) and eukaryotic (e.g. Pichia) microbes in combination with a variety of fermentation substrates (e.g. coffee berry pulp; dry malt extract, etc.) and combining said microbes and fermentation substrates with the aforementioned base formula of plant-derived ingredients. In some examples, the brewed coffee substitute beverages produced from the combination of Lactic acid bacteria and/or acetic acid cultures and Pichia and/or Saccharomyces and/or Torulaspora yeast cultures had a greater fruitiness, acidity, and complexity compared with the beverage produced from the base formula of plant ingredients alone.

The combination of the refined base formula of unfermented plant-derived ingredients with fermented ingredients (e.g., microbes and fermentation substrates) yielded a brewed coffee substitute beverage with flavor characteristics similar to brewed coffee. These compositions may also be modified to include additional synthetic or naturally-derived additives, e.g., flavorants, as described herein.

For example, described herein are compositions configured to be brewed to form a coffee-like beverage. These compositions may generally include a mixture of a plant-based formulation (formed from plant-based derivatives of ground and in some cases roasted nuts, seeds, stalks, etc.) combined with a fermented substrate (the substrate may also be a plant-based derivative). Optionally, the composition may also include one or more flavorant(s) (also referred to as flavor enhancer(s)), such as natural flavors, e.g., natural coffee flavors, natural chocolate flavors, Guaiacol, 4-ethylguaiacol, 4-vinylguaiacol, 3-mercapto-3-methylbutylformate, 2-furfurylthiol, Furaneol, 2,3-pentanedione, 3-methylbutanoic acid, 3-methybutanal, P-cresol, 2,3-dimethylpyrazine, 2-methylbutanal, 2-methylpropanal, Maltol, Phenylacetaldehyde, Phenylacetic acid, Linalool, Damascenone, 2-ethyl-3,5 dimethyl pyrazine, 2 ethyl 5(6) methyl pyrazine, 2-acetyl-1-methylpyrrole, EHMF (5-Ethyl-3-hydroxy-4-methyl-2(5H)-furanone), 2-isolbutyl-3-methoxypyrazine, 2-sec-butyl-3-methoxypyrazine, 2,3-diethyl-5-methylpyrazine, pyridine, 3-(methylthio)butanal, 2,5-dimethyl pyrazine, 2 methyl tetrahydrofuran-3-one, 2 ethyl 3 methylpyrazine, 2 methylpyrazine and bell pepper pyrazine (3-isolbutyl-2-methoxypyrazine), 1,2-Cyclopentanedione 3-methyl-; 1H-Pyrrole, 1-(2-furanylmethyl)-; 1H-Pyrrole, 1-methyl-; 1H-Pyrrole, 1-pentyl-; 1-Hydroxy-2-butanone; 2(3H)-Furanone, 5-acetyldihydro-; 2(5H)-Furanone; 2-Acetyl-3-methylpyrazine; 2-Acetyl-5-methylfuran; 2-Butenoic acid, 3-methyl-; 2-Cyclopenten-1-one, 3-ethyl-2-hydroxy-; 2-Furanmethanol, propanoate; 2-Hydroxy-3-pentanone; 2-n-Butyl furan; 2-Propanone, 1-hydroxy-; 2-Thiophenemethanol; 3(2H)-Thiophenone, dihydro-2-methyl-; 3-Thiophenecarboxaldehyde; Acetoin; Acetone; Acetylpyrazine; Butyrolactone; Ethanone, 1-(1H-pyrrol-2-yl)-; Ethanone, 1-(1-methyl-1H-pyrrol-2-yl)-; Ethanone, 1-(2-pyridinyl)-; Furan, 2-(2-furanylmethyl)-5-methyl-; Furan, 2,2′-methylenebis-; Furan, 2-[(methylthio)methyl]-; Furan, 2-methyl-; Furan, 4,5-diethyl-2,3-dihydro-2,3-dimethyl-; Propanoic acid; Pyrazine; Pyrazine, 2,6-dimethyl-; Pyrazine, ethyl-; Pyridine, 3-ethyl-; Pyridine, 3-methyl-; Pyrrole; 1H-Pyrrole-2-carboxaldehyde; 1H-Pyrrole-2-carboxaldehyde, 1-methyl-; 2-Butanone, 1-(acetyloxy)-; 2-Furancarboxaldehyde, 5-methyl-; 2-Furanmethanol; 2-Furanmethanol, acetate; 2-Propanone, 1-hydroxy-; Acetaldehyde; Acetoin; Butyrolactone; Ethanone, 1-(2-furanyl)-; Furan, 2-methyl-; Furfural; Pyrazine, 2,6-dimethyl-; Pyrazine, 3-ethyl-2,5-dimethyl-; Pyrazine, ethyl- etc.

For example, compositions configured to be brewed to form a coffee-like beverage may comprise: a mixture of a plant-based formulation and a fermented substrate, wherein the plant-based formulation comprises a mixture of plant-based derivatives comprising any one or more of: 5%-50% roasted and ground chicory, 5%-25% roasted and ground sunflower seeds, 5%-30% roasted and ground lentils, 2%-20% malts, 5-60% date seeds, 0.1-25% grape seeds or its extract, 1-20% cinchona bark, 0.1-5% dandelion, 0.1-5% wormwood, 3.5%-5% of guarana extract or 0.01-0.62% pure caffeine, 0.1%-25% roasted and ground carob or kibbles or pods or their extract, and 0.05%-3% of organic acids including but not limited to chlorogenic acid (CGA), citric, malic, tartaric, fumaric, valeric, butyric, formic and propionic acids, in the dry blend that will be used to brew the coffee substitute beverage; further wherein the fermented substrate is included at between about 1% and 80% of the weight of the plant-based brewed formulation and comprises one or more of: fermented de-pitted coffee cherry fruits, fermented coffee pulp, fermented carob, fermented oats, fermented oat malt, fermented malt extract, fermented pomegranate pomace or its extract, fermented date seeds, fermented chicory, fermented figs, fermented sunflower seeds, fermented citrus fruit peel, and fermented fenugreek where in the output is the fermented solid substrate or the liquid with water soluble metabolites after fermentation of these substrates.

The ranges of the plant-based derivatives included in the plant-based formulation are important in forming a beverage that has the target flavor profiles, and particularly a beverage that has the flavor profile of coffee. Outside of these ranges the resulting brewed beverage does not have the required flavor profile.

In any of these compositions the fermented substrate may comprise residual fermentation microbial remains consisting of remains of one or more of: Pichia fermentans, Pichia guilliermondii, Torulaspora delbrueckii, Saccharomyces cerevisiae, Lactobacillus plantarum, Lactococcus lactis, Rhizopus oligosporus, Candida parapsilosis, and Pichia kluyveri, depending on the fermentation method used. Thus the final composition may include detectable amounts of the remains of these fermentation microbes. In some cases the final composition may also or alternatively include signature fermentation materials (e.g., alcohols). These residual fermentation microbial remains may be detected by, e.g., polymerase chain reaction (PCR)-based detection techniques.

As used herein, the term “residual fermentation microbial remains” may refer to the presence of non-viable (e.g., dead) microbes or byproducts specific to these microbes, such as genetic material or proteins characteristic of these microbes. The composition may be pasteurized or otherwise treated to destroy the fermentation microbes, however the residual fermentation microbe remains (also referred to herein as just residual fermentation microbes, for simplicity) may be detectable.

The fermented substrate may comprise one or more of fermented de-pitted coffee cherry fruits, fermented coffee cherry pulp, or fermented carob, fermented pomegranate pomace or its extract, fermented date seeds, fermented sunflower seeds, fermented chicory, fermented figs, fermented citrus fruit peel, fermented malts or its extracts and fermented fenugreek which has been fermented with one or more of Pichia fermentans, Pichia guilliermondii, Torulaspora delbrueckii, Leuconostoc mesenteroides, Lactobacillus paracasei, Lactobacillus acidophilus, Lactobacillus bulgaricus, Lactobacillus helveticus, Acetobacter spp., Gluconobacter spp., Lachancea thermotolerans. The fermented substrate may comprise both dried fermented solids and fermentation liquid.

The malt may be one or more of rice malt, oat malt, barley malt, corn malt, millet malt and/or coffee malt.

Any of the component plant-based derivatives may be whole or ground. The grounds include desired particle size, such as 200-1500 micrometers (median particle size) wherein at least 85% by weight of said plant-derived ingredients have a particle size in the range of 200-1000 micrometers. The plant-based derivatives may be roasted, and individual plant-based derivatives may be roasted within a predefined range. For example, the sunflower seeds may be roasted between about 180 and 400 degrees C. and then ground. The carob may be roasted to 160-380 degrees C. and then ground.

In some examples, the plant-based formulation may further comprise 6%-16% of ground roasted fenugreek. For example, the plant-based formulation may further comprise one or more of: between about 6%-16% of ground fenugreek, between about 0.2%-1% quinic acid, between about 4%-8% of ground tomato flakes, between about 5%-11% ground pumpkin seeds; between about 0.5%-2% yeast; and between about 0.1%-0.5% ground juniper berries.

The plant-based formulation may further comprise one or more of ground, powdered or dehydrated: acorn, asparagus seeds, barley, buckwheat, black eyed peas, burdock, Cabernet Sauvignon wine flour, caffeine, carrots, chana dal chickpeas, chocolate, cocoa, cacao, cinnamon, citric acid, coriander seeds, corn, cranberry seeds, dandelion root, dried tomato flakes, fenugreek, figs, rice, grape seeds, grape seed extract, green split peas, guarana extract, juniper berries, lentils, mango, mesquite, caramel millet, chocolate pale malt, coffee malt, Reishi mushrooms, oats, okra, orange peel, pale corn, pumpkin seeds, quinic acid, ramon seeds, raspberry seeds, rye, Saborizante Artificial, Sacha inchi seeds, soybeans, strawberry seeds, sugar beets, tamarind seeds, turmeric, and yeast.

In any of these compositions, the plant-based formulation may be composed of melanoidins by at least 5% by weight. The chlorogenic acid may be at a concentration of at least 0.9% by weight.

The composition may be part of a package that may be configured for ease of brewing and/or consumption. For example, the composition may be packaged within one or more of: a paper bag, a foil package, a plastic container, ajar or a canister.

Any of these compositions may include between about 0.1 and 3% of one or more of: Guaiacol, 4-ethylguaiacol, 4-vinylguaiacol, 3-mercapto-3-methylbutylformate, 2-furfurylthiol, Furaneol, 2,3-pentanedione, 3-methylbutanoic acid, 3-methybutanal, P-cresol, 2,3-dimethylpyrazine, 2-methylbutanal, 2-methylpropanal, Maltol, Phenylacetaldehyde, Phenylacetic acid, Linalool, Damascenone, 2-ethyl-3,5 dimethyl pyrazine, 2 ethyl 5(6) methyl pyrazine, 2-acetyl-1-methylpyrrole, EHMF (5-Ethyl-3-hydroxy-4-methyl-2(5H)-furanone), 2-isolbutyl-3-methoxypyrazine, 2-sec-butyl-3-methoxypyrazine, 2,3-diethyl-5-methylpyrazine, pyridine, 3-(methylthio)butanal, 2,5-dimethyl pyrazine, 2 methyl tetrahydrofuran-3-one, 2 ethyl 3 methylpyrazine, 2 methylpyrazine and bell pepper pyrazine (3-isolbutyl-2-methoxypyrazine), 1,2-Cyclopentanedione 3-methyl-; 1H-Pyrrole, 1-(2-furanylmethyl)-; 1H-Pyrrole, 1-methyl-; 1H-Pyrrole, 1-pentyl-; 1-Hydroxy-2-butanone; 2(3H)-Furanone, 5-acetyldihydro-; 2(5H)-Furanone; 2-Acetyl-3-methylpyrazine; 2-Acetyl-5-methylfuran; 2-Butenoic acid, 3-methyl-; 2-Cyclopenten-1-one, 3-ethyl-2-hydroxy-; 2-Furanmethanol, propanoate; 2-Hydroxy-3-pentanone; 2-n-Butyl furan; 2-Propanone, 1-hydroxy-; 2-Thiophenemethanol; 3(2H)-Thiophenone, dihydro-2-methyl-; 3-Thiophenecarboxaldehyde; Acetoin; Acetone; Acetylpyrazine; Butyrolactone; Ethanone, 1-(1H-pyrrol-2-yl)-; Ethanone, 1-(1-methyl-1H-pyrrol-2-yl)-; Ethanone, 1-(2-pyridinyl)-; Furan, 2-(2-furanylmethyl)-5-methyl-; Furan, 2,2′-methylenebis-; Furan, 2-[(methylthio)methyl]-; Furan, 2-methyl-; Furan, 4,5-diethyl-2,3-dihydro-2,3-dimethyl-; Propanoic acid; Pyrazine; Pyrazine, 2,6-dimethyl-; Pyrazine, ethyl-; Pyridine, 3-ethyl-; Pyridine, 3-methyl-; Pyrrole; 1H-Pyrrole-2-carboxaldehyde; 1H-Pyrrole-2-carboxaldehyde, 1-methyl-; 2-Butanone, 1-(acetyloxy)-; 2-Furancarboxaldehyde, 5-methyl-; 2-Furanmethanol; 2-Furanmethanol, acetate; 2-Propanone, 1-hydroxy-; Acetaldehyde; Acetoin; Butyrolactone; Ethanone, 1-(2-furanyl)-; Furan, 2-methyl-; Furfural; Pyrazine, 2,6-dimethyl-; Pyrazine, 3-ethyl-2,5-dimethyl-; Pyrazine, ethyl-, etc. or other natural flavorings.

Also described herein are brewed coffee-like beverages comprising: an aqueous solution comprising a mixture of a plant-based formulation and a fermented substrate, wherein the plant-based formulation comprises: 5%-50% roasted and ground chicory, 5%-25% roasted and ground sunflower seeds, 5%-30% roasted and ground lentils, 2%-20% malts, 5-60% date seeds, 0.1-25% grape seeds or its extract, 1-20% cinchona bark, 0.1-5% dandelion, 0.1-5% wormwood, 3.5%-5% of guarana extract or 0.01-0.62% pure caffeine, 0.1%-25% roasted and ground carob or kibbles or pods or their extract, and 0.05%-3% of organic acids including but not limited to chlorogenic acid (CGA), citric, malic, tartaric, fumaric, valeric, butyric, formic and/or propionic acids, in the dry blend that will be used to brew the coffee substitute beverage; further wherein the fermented substrate is included at between about 1% and 80% of the weight of the plant-based brewed formulation and comprises one or more of: fermented de-pitted coffee cherry fruits, fermented coffee pulp, fermented carob, fermented oats, fermented oat malt, fermented malt extract, fermented pomegranate pomace or its extract, fermented date seeds, fermented chicory, fermented figs, fermented sunflower seeds, fermented citrus fruit peel, and fermented fenugreek where in the output is the fermented solid substrate or the liquid with water soluble metabolites after fermentation of these substrates.

As mentioned above, the fermented substrate may comprise residual fermentation microbial remains consisting of one or more of: Pichia fermentans, Pichia guilliermondii, Torulaspora delbrueckii, Saccharomyces cerevisiae, Lactobacillus plantarum, Lactococcus lactis, Rhizopus oligosporus, Caidida parapsilosis, and Pichia kluyveri. The brewed coffee-like beverages may include any of the components discussed above.

Also described herein are methods of forming a composition configured to be brewed to form a coffee-like beverage, as well as methods of brewing a coffee-like beverage. For example, a method of forming a composition configured to be brewed to form a coffee-like beverage may include: preparing a plant-based mixture of: 5%-50% roasted and ground chicory, 5%-25% roasted and ground sunflower seeds, 5%-30% roasted and ground lentils, 2%-20% malts, 5-60% date seeds, 0.1-25% grape seeds or its extract, 1-20% cinchona bark, 0.1-5% dandelion, 0.1-5% wormwood, 3.5%-5% of guarana extract or 0.01-0.62% pure caffeine, 0.1%-25% roasted and ground carob or kibbles or pods or their extract, and 0.05%-3% of organic acids including but not limited to chlorogenic acid (CGA), citric, malic, tartaric, fumaric, valeric, butyric, formic and/or propionic acids, in the dry blend that will be used to brew the coffee substitute beverage; further wherein the fermented substrate is included at between about 1% and 80% of the weight of the plant-based brewed formulation and comprises one or more of: fermented de-pitted coffee cherry fruits, fermented coffee pulp, fermented carob, fermented oats, fermented oat malt, fermented malt extract, fermented pomegranate pomace or its extract, fermented date seeds, fermented chicory, fermented figs, fermented sunflower seeds, fermented citrus fruit peel, and fermented fenugreek where in the output is the fermented solid substrate or the liquid with water soluble metabolites after fermentation of these substrates.

Any of these methods may include forming the fermented substrate by adding a starter culture comprising at least one microorganism strain or a consortium of microorganisms to a substrate comprising one or more of fermented de-pitted coffee cherry fruits, fermented coffee pulp, fermented carob, fermented oats, fermented oat malt, fermented malt extract, fermented pomegranate pomace or its extract, fermented date seeds, fermented chicory, fermented figs, fermented sunflower seeds, fermented citrus fruit peel, and fermented fenugreek, wherein the starter culture the cell density range from 10⁵ to 10⁸ CFU/mL; and fermenting the substrate.

For example, the method may include adding one or more of: sugar substitutes and organic acids to the mixture of starter culture and substrate. The method may include adding one or more of: a phosphate, and a phosphate analogue to the mixture of starter culture and substrate. The one or more microorganisms may be selected from the group consisting of: Lactococcus lactis, Lactobacillus plantarum, Bacillus subitilis, Rhizopus oligosporus, Pichia fermentans, Torulaspora delbrueckii, Saccharomyces cerevisiae, Pichia guilliermondii, Leuconostoc mesenleroides, Lactobacillus paracasei, Lactobacillus acidophilus, Laclobacillus bulgaricus, Laclobacillus helveticus, Acetobacter spp., Gluconobacter spp., Lachancea thermotolerans.

The fermentation may proceed for 0.2-3 days at between about 24 degrees C. to 37 degrees C. In some examples, the fermentation process may proceed for at least 5 days at 25 degrees C. or more. The fermentation may proceed for at least 7 days at room temperature. Any of these methods may include processing the fermented substrate by separating liquid from solid material by one or more of: filtration, pressing, oven drying, air drying, forced-air drying, or vacuum drying. For example, the method may include obtaining, from the liquid material, dried fermented solids with a final moisture content of less than 10% weight by weight. The method may further include drying the fermented solids by one or more of: filtration, pressing, oven drying, air drying, forced-air drying, or vacuum drying to a final moisture content of 10% weight by weight.

In any of these methods adding the fermented substrate to the plant-based mixture may include adding both dried fermented solids and fermentation liquid.

The malt may be one or more of rice malt, oat malt, barley malt, corn malt, millet malt and/or coffee malt. The malt may be roasted. Any of these methods may include roasting one or more of the plant-based derivative components and/or grinding the components into the desired particle range. Some or all of these components may be roasted together and/or they may be roasted separately. The roasting temperature may be within a specified range. For example, the sunflower seeds may be roasted between about 180 and 400 degrees C. prior to grinding.

The plant-based formulation may further include between about 6%-16% of ground roasted fenugreek. For example, the plant-based formulation may further comprise one or more of: between about 6%-16% of ground fenugreek, between about 0.2%-1% quinic acid, between about 4%-8% of ground tomato flakes, between about 5%-11% ground pumpkin seed; between about 0.5%-2% yeast; and between about 0.1%-0.5% ground juniper berries.

In some examples the plant-based formulation may further comprise one or more of ground, powdered or dehydrated: acorn, asparagus seed, barley, buckwheat, black eyed peas, burdock, Cabernet Sauvignon wine, flour, caffeine, carrots, chana dal chickpeas, chocolate, cocoa, cacao, cinnamon, citric acid, coriander seeds, corn, cranberry seeds, dandelion root, dried tomato flakes, fenugreek, figs, rice, grape seed extract, green split peas, guarana extract, juniper berries, lentils, mango, mesquite, caramel millet, chocolate pale malt, coffee malt, Reishi mushrooms, oats, okra, orange peel, mushrooms, orange peel, pale corn, pumpkin seeds, quinic acid, ramon seeds, raspberry seeds, rye, Saborizante Artificial, Sacha inchi seeds, soybeans, strawberry Seeds, sugar beets, tamarind seeds, turmeric, and yeast.

The plant-based formulation may have a median particle size in the range of 200-1500 micrometers and at least 85% by weight of said plant-based formulation has a particle size in the range of 200-1000 micrometers. Any of these methods may include grinding and selecting the particles of the plant-based formulation.

Any of these methods may include forming the plant-based formulation so that it is composed of melanoidins by at least 5% by weight. In some examples the plant-based formulation contains chlorogenic acid at a concentration of at least 0.9% by weight.

As mentioned above, any of these methods may include packaging the composition for later ease and freshness of brewing, including packing within one or more of: a foil package, a water-permeable bag, ajar or a canister.

Any of these methods may include adding between about 0.1 and 3% of one or more of: Guaiacol, 4-ethylguaiacol, 4-vinylguaiacol, 3-mercapto-3-methylbutylformate, 2-furfurylthiol, Furaneol, 2,3-pentanedione, 3-methylbutanoic acid, 3-methybutanal, P-cresol, 2,3-dimethylpyrazine, 2-methylbutanal, 2-methylpropanal, Maltol, Phenylacetaldehyde, Phenylacetic acid, Linalool, Damascenone, 2-ethyl-3,5 dimethyl pyrazine, 2 ethyl 5(6) methyl pyrazine, 2-acetyl-1-methylpyrrole, EHMF (5-Ethyl-3-hydroxy-4-methyl-2(5H)-furanone), 2-isolbutyl-3-methoxypyrazine, 2-sec-butyl-3-methoxypyrazine, 2,3-diethyl-5-methylpyrazine, pyridine, 3-(methylthio)butanal, 2,5-dimethyl pyrazine, 2 methyl tetrahydrofuran-3-one, 2 ethyl 3 methylpyrazine, 2 methylpyrazine and bell pepper pyrazine (3-isolbutyl-2-methoxypyrazine), 1,2-Cyclopentanedione 3-methyl-; 1H-Pyrrole, 1-(2-furanylmethyl)-; 1H-Pyrrole, 1-methyl-; 1H-Pyrrole, 1-pentyl-; 1-Hydroxy-2-butanone; 2(3H)-Furanone, 5-acetyldihydro-; 2(5H)-Furanone; 2-Acetyl-3-methylpyrazine; 2-Acetyl-5-methylfuran; 2-Butenoic acid, 3-methyl-; 2-Cyclopenten-1-one, 3-ethyl-2-hydroxy-; 2-Furanmethanol, propanoate; 2-Hydroxy-3-pentanone; 2-n-Butyl furan; 2-Propanone, 1-hydroxy-; 2-Thiophenemethanol; 3(2H)-Thiophenone, dihydro-2-methyl-; 3-Thiophenecarboxaldehyde; Acetoin; Acetone; Acetylpyrazine; Butyrolactone; Ethanone, 1-(1H-pyrrol-2-yl)-; Ethanone, 1-(1-methyl-1H-pyrrol-2-yl)-; Ethanone, 1-(2-pyridinyl)-; Furan, 2-(2-furanylmethyl)-5-methyl-; Furan, 2,2′-methylenebis-; Furan, 2-[(methylthio)methyl]-; Furan, 2-methyl-; Furan, 4,5-diethyl-2,3-dihydro-2,3-dimethyl-; Propanoic acid; Pyrazine; Pyrazine, 2,6-dimethyl-; Pyrazine, ethyl-; Pyridine, 3-ethyl-; Pyridine, 3-methyl-; Pyrrole; 1H-Pyrrole-2-carboxaldehyde; 1H-Pyrrole-2-carboxaldehyde, 1-methyl-; 2-Butanone, 1-(acetyloxy)-; 2-Furancarboxaldehyde, 5-methyl-; 2-Furanmethanol; 2-Furanmethanol, acetate; 2-Propanone, 1-hydroxy-; Acetaldehyde; Acetoin; Butyrolactone; Ethanone, 1-(2-furanyl)-; Furan, 2-methyl-; Furfural; Pyrazine, 2,6-dimethyl-; Pyrazine, 3-ethyl-2,5-dimethyl-; Pyrazine, ethyl- etc., or other natural flavorings to the plant-based mixture.

Also described herein are methods of preparing any of these compositions described herein, including (but not limited to) method of preparing a brewed coffee-like beverage from the composition by a French press method, e.g., by adding water at about 205 degrees Fahrenheit to the composition, steeping, and decanting. A method of preparing a brewed coffee-like beverage from any of these compositions may also include cold brewing a coffee-like beverage from the composition by adding water to the composition in a 1:1 to 1:10 ratio (ingredients:water) at 22 degrees C., mixing and steeping for at least 0.5 to 18 hours at 4 degrees C. and filtering, or high pressure extraction, combination or high pressure/high temperature extraction, sub-critical water extraction, supercritical carbon dioxide extraction.

For example, described herein are compositions configured to form a coffee-like beverage, the composition comprising: a mixture of a plant-based formulation and a fermented fermentation substrate, wherein the plant-based formulation is unfermented; further wherein the fermented substrate is included at between about 1% and 80% of the weight of the plant-based formulation, and wherein the fermented fermentation substrate comprises one or more of: fermented de-pitted coffee cherry fruits, fermented coffee pulp, fermented carob, fermented oats, fermented oat malt, fermented malt extract, fermented pomegranate pomace or its extract, fermented date seeds, fermented chicory, fermented figs, fermented sunflower seeds, fermented citrus fruit peel, and fermented fenugreek, further wherein the fermented fermentation substrate comprises one or both of a fermentation solid and/or a fermentation liquid extract of the fermented fermentation substrate.

The plant-based formulation may comprise one or more of: between about 5%-50% w/w ground chicory, between about 5%-60% w/w date seeds, between about 0.1%-25% w/w grape seeds or grape seed extract, and between about 0.01-0.62% caffeine. In some examples the plant-based formulation may comprise each of: between about 5%-50% w/w ground chicory, between about 5%-60% w/w date seeds, between about 0.1%-25% w/w grape seeds or grape seed extract, and between about 0.01-0.62% caffeine. One or more additional composition may be included in any of these plant-based formulations. For example, the plant-based formulation may comprises one or more of: between about 5%-25% w/w ground sunflower seeds, between about 5%-30% w/w ground lentil, between about 2%-20% w/w malt or malt extract, between about 1%-20% cinchona bark, between about 0.1%-5% dandelion, between about 0.1%-5% wormwood, between about 3.5%-5% w/w of guarana extract, between about 0.1%-25% w/w carob kibbles or pods or grounds or extract, and/or between about 0.05%-3% organic acids including but not limited to chlorogenic acid (CGA), citric, malic, tartaric, fumaric, valeric, butyric, formic and propionic acids.

The fermented fermentation substrate may comprise residual fermentation microbial remains of one or more of: Pichia fermentans, Pichia guilliermondii, Torulaspora delbrueckii, Saccharomyces cerevisiae, Lactobacillus plantarum, Lactococcus lactis, Rhizopus oligosporus, Candida parapsilosis, and Pichia kluyveri. The residual fermentation microbial remains may be detected in the product by any appropriate technique, including gene amplification (e.g., PCR) to detect a polynucleotide sequence specific to the microorganism (e.g., Pichia fermentans, Pichia guilliermondii, Tornlaspora delbrueckii, Saccharomyces cerevisiae, Lactobacillus plantarum, Lactococcus lactis. Rhizopus oligosporus, Candida parapsilosis, and Pichia kluyveri).

The fermented fermentation substrate may comprise a fermentation liquid extract comprising water-soluble metabolites of the fermented fermentation substrate. The fermented fermentation substrate may comprise one or more of: fermented de-pitted coffee cherry fruits, fermented coffee cherry pulp, fermented carob, fermented pomegranate pomace or pomegranate pomace extract, fermented date seeds, fermented sunflower seeds, fermented chicory, fermented figs, fermented citrus fruit peel, fermented malt or malt extract, and fermented fenugreek which has been fermented with one or more of: Pichia fermentans, Pichia guilliermondii, Torulaspora delbrueckii, Saccharomyces cerevisiae, Lactobacillus plantarum, Lactococcus lactis, Rhizopus oligosporus, Candida parapsilosis, Pichia kluyveri, Leuconostoc mesenteroides, Lactobacillus paracasei, Lactobacillus acidophilus, Lactobacillus bulgaricus, Lactobacillus helveticus, Acetobacter spp., Gluconobacter spp., and Lachancea thermotolerans. In some examples the fermented fermentation substrate comprises both the fermentation solid and the fermentation liquid extract of the fermented fermentation substrate.

The chlorogenic acid may be recombinant chlorogenic acid. The malt extract is one or more of rice malt, oat malt, barley malt, corn malt, millet malt and coffee malt. The ground sunflower may be roasted. The carob may be roasted. The plant-based formulation may further comprises between about 6%-16% w/w of ground roasted fenugreek. The plant-based formulation may further include one or more of: between about 6%-16% w/w of ground fenugreek, between about 0.2%-1% w/w quinic acid, between about 4%-8% w/w of ground tomato flakes, between about 5%-11% w/w ground pumpkin seed; between about 0.5%-2% w/w yeast; and between about 0.1%-0.5% w/w ground juniper berries.

The plant-based formulation may further include one or more of ground, powdered or dehydrated: acorn, asparagus seed, barley, buckwheat, black eyed peas, burdock, Cabernet Sauvignon wine, flour, caffeine, carrots, chana dal chickpeas, chocolate, cocoa, cacao, cinnamon, citric acid, coriander seeds, corn, cranberry seeds, dandelion root, dried tomato flakes, fenugreek, figs, rice, grape seed extract, green split peas, guarana extract, juniper berries, lentils, mango, mesquite, caramel millet, chocolate pale malt, coffee malt, Reishi mushrooms, oats, okra, orange peel, mushrooms, orange peel, pale corn, pumpkin seeds, quinic acid, ramon seeds, raspberry seeds, rye, Saborizante Artificial, Sacha inchi seeds, soybeans, strawberry Seeds, sugar beets, tamarind seeds, turmeric, and yeast. The plant-based formulation may have a median particle size in the range of 200-1500 micrometers. The plant-based formulation may have a median particle size in the range of 200-1500 micrometers and at least 85% by weight of said plant-based formulation have a particle size in the range of 200-1000 micrometers. The plant-based formulation may include at least 5% by weight of melanoidins. In some examples the plant-based formulation comprises chlorogenic acid at a concentration of at least 0.9% by weight.

The composition may be packaged in any appropriate technique; for example, the composition may be sealed within one or more of: a foil package, a water-permeable bag, ajar or a canister.

The composition of claim 1, further comprising between about 0.1 and 3% w/w of one or more of: Guaiacol, 4-ethylguaiacol, 4-vinylguaiacol, 3-mercapto-3-methylbutylformate, 2-furfurylthiol, Furaneol, 2,3-pentanedione, 3-methylbutanoic acid, 3-methybutanal, P-cresol, 2,3-dimethylpyrazine, 2-methylbutanal, 2-methylpropanal, Maltol, Phenylacetaldehyde, Phenylacetic acid, Linalool, Damascenone, 2-ethyl-3,5 dimethyl pyrazine, 2 ethyl 5(6) methyl pyrazine, 2-acetyl-1-methylpyrrole, EHMF (5-Ethyl-3-hydroxy-4-methyl-2(5H)-furanone), 2-isolbutyl-3-methoxypyrazine, 2-sec-butyl-3-methoxypyrazine, 2,3-diethyl-5-methylpyrazine, pyridine, 3-(methylthio)butanal, 2,5-dimethyl pyrazine, 2 methyl tetrahydrofuran-3-one, 2 ethyl 3 methylpyrazine, 2 methylpyrazine and bell pepper pyrazine (3-isolbutyl-2-methoxypyrazine), 1,2-Cyclopentanedione 3-methyl-; 1H-Pyrrole, 1-(2-furanylmethyl)-; 1H-Pyrrole, 1-methyl-; 1H-Pyrrole, 1-pentyl-; 1-Hydroxy-2-butanone; 2(3H)-Furanone, 5-acetyldihydro-; 2(5H)-Furanone; 2-Acetyl-3-methylpyrazine; 2-Acetyl-5-methylfuran; 2-Butenoic acid, 3-methyl-; 2-Cyclopenten-1-one, 3-ethyl-2-hydroxy-; 2-Furanmethanol, propanoate; 2-Hydroxy-3-pentanone; 2-n-Butyl furan; 2-Propanone, 1-hydroxy-; 2-Thiophenemethanol; 3(2H)-Thiophenone, dihydro-2-methyl-; 3-Thiophenecarboxaldehyde; Acetoin; Acetone; Acetylpyrazine; Butyrolactone; Ethanone, 141H-pyrrol-2-yl)-; Ethanone, 1-(1-methyl-1H-pyrrol-2-yl)-; Ethanone, 1-(2-pyridinyl)-; Furan, 2-(2-furanylmethyl)-5-methyl-; Furan, 2,2′-methylenebis-; Furan, 2-[(methylthio)methyl]-; Furan, 2-methyl-; Furan, 4,5-diethyl-2,3-dihydro-2,3-dimethyl-; Propanoic acid; Pyrazine; Pyrazine, 2,6-dimethyl-; Pyrazine, ethyl-; Pyridine, 3-ethyl-; Pyridine, 3-methyl-; Pyrrole; 1H-Pyrrole-2-carboxaldehyde; 1H-Pyrrole-2-carboxaldehyde, 1-methyl-; 2-Butanone, 1-(acetyloxy)-; 2-Furancarboxaldehyde, 5-methyl-; 2-Furanmethanol; 2-Furanmethanol, acetate; 2-Propanone, 1-hydroxy-; Acetaldehyde; Acetoin; Butyrolactone; Ethanone, 1-(2-furanyl)-; Furan, 2-methyl-; Furfural; Pyrazine, 2,6-dimethyl-; Pyrazine, 3-ethyl-2,5-dimethyl-; Pyrazine, ethyl-.

Also described herein are compositions configured to form a coffee-like beverage that include: a mixture of a plant-based formulation that is unfermented and a fermented fermentation substrate, wherein the plant-based formulation comprises: between about 5%-50% w/w ground chicory, between about 5%-60% w/w date seeds, between about 0.1%-25% w/w grape seeds or grape seed extract, and between about 0.01-0.62% caffeine; further wherein the fermented fermentation substrate is included at between about 1% and 80% of the weight of the plant-based formulation, and wherein the fermented fermentation substrate comprises one or more of: fermented de-pitted coffee cherry fruits, fermented coffee pulp, fermented carob, fermented oats, fermented oat malt, fermented malt extract, fermented pomegranate pomace or its extract, fermented date seeds, fermented chicory, fermented figs, fermented sunflower seeds, fermented citrus fruit peel, and fermented fenugreek, further wherein the fermented substrate comprises one or both of a fermentation solid and/or a fermentation liquid extract of the fermented fermentation substrate and comprises residual fermentation microbial remains of one or more of: Pichia fermentans, Pichia guilliermondii, Torulaspora delbrueckii, Saccharomyces cerevisiae, Lactobacillus plantarum, Lactococcus lactis, Rhizopus oligosporus, Candida parapsilosis, and Pichia kluyveri.

For example, a brewed coffee-like beverage may include: an aqueous solution comprising a mixture of a plant-based formulation that is unfermented and a fermented fermentation substrate, wherein the plant-based formulation comprises: between about 5%-50% w/w ground chicory, between about 5%-60% w/w date seeds, between about 0.1%-25% w/w grape seeds or grape seed extract and between about 0.01-0.62% caffeine, further wherein the plant-based formulation comprises one or more of: between about 5%-25% w/w ground sunflower seeds, between about 5%-30% w/w ground lentil, between about 2%-20% w/w malt or malt extract, between about 1%-20% cinchona bark, between about 0.1%-5% dandelion, between about 0.1%-5% wormwood, between about 3.5%-5% w/w of guarana extract, between about 0.1%-25% w/w carob kibbles or pods or grounds or extract and/or between about 0.05%-3% organic acids including but not limited to chlorogenic acid (CGA), citric, malic, tartaric, fumaric, valeric, butyric, formic and propionic acids; further wherein the fermented fermentation substrate is included at between about 1% and 80% of the weight of the plant-based brewed formulation and comprises one or more of: fermented de-pitted coffee cherry fruits, fermented coffee pulp, fermented carob, fermented oats, fermented oat malt, fermented malt extract, fermented pomegranate pomace or its extract, fermented date seeds, fermented chicory, fermented figs, fermented sunflower seeds, fermented citrus fruit peel, and fermented fenugreek, wherein the fermented fermentation substrate comprises one or both of a fermentation solid and/or a fermentation liquid extract of the fermented fermentation substrate.

In some examples the fermented fermentation substrate comprises residual fermentation microbial remains of one or more of: Pichia fermentans, Pichia guilliermondii, Torulaspora delbrueckii, Saccharomyces cerevisiae, Lactobacillus plantarum, Lactococcus lactis, Rhizopus oligosporus, Candida parapsilosis, Pichia kluyveri.

The chlorogenic acid may be recombinant chlorogenic acid. The malt extract may be one or more of rice malt, barley malt, oat malt, corn malt, millet malt and coffee malt. The sunflower may be roasted. The plant-based formulation may further include one or more of: between about 6%-16% w/w of fenugreek, between about 0.2%-1% w/w quinic acid, between about 4%-8% w/w of tomato flakes, between about 5%-11% w/w ground pumpkin seed; between about 0.5%-2% w/w yeast; and between about 0.1%-0.5% w/w ground juniper berries. The plant-based formulation may further comprise one or more of ground, powdered or dehydrated: acorn, asparagus seed, barley, buckwheat, black eyed peas, burdock, Cabernet Sauvignon wine, flour, caffeine, carrots, chana dal chickpeas, chocolate, cocoa, cacao, cinnamon, citric acid, coriander seeds, corn, cranberry seeds, dandelion root, dried tomato flakes, fenugreek, figs, rice, grape seed extract, green split peas, guarana extract, juniper berries, lentils, mango, mesquite, caramel millet, chocolate pale malt, coffee malt, Reishi mushrooms, oats, okra, orange peel, mushrooms, orange peel, pale corn, pumpkin seeds, quinic acid, ramon seeds, raspberry seeds, rye, Saborizante Artificial, Sacha inchi seeds, soybeans, strawberry Seeds, sugar beets, tamarind seeds, turmeric, and yeast.

The plant-based formulation may have a median particle size in the range of 200-1500 micrometers. For example, the plant-based formulation may have a median particle size in the range of 200-1500 micrometers and at least 85% by weight of said plant-based formulation has a particle size in the range of 200-1000 micrometers.

The aqueous solution may comprise melanoidins by at least 5% by weight. In some examples the aqueous solution contains chlorogenic acid at a concentration of at least 0.9% by weight.

The brewed coffee-like beverage may include between about 0.1 and 3% w/w of one or more of: Guaiacol, 4-ethylguaiacol, 4-vinylguaiacol, 3-mercapto-3-methylbutylformate, 2-furfurylthiol, Furaneol, 2,3-pentanedione, 3-methylbutanoic acid, 3-methybutanal, P-cresol, 2,3-dimethylpyrazine, 2-methylbutanal, 2-methylpropanal, Maltol, Phenylacetaldehyde, Phenylacetic acid, Linalool, Damascenone, 2-ethyl-3,5 dimethyl pyrazine, 2 ethyl 5(6) methyl pyrazine, 2-acetyl-1-methylpyrrole, EHMF (5-Ethyl-3-hydroxy-4-methyl-2(5H)-furanone), 2-isolbutyl-3-methoxypyrazine, 2-sec-butyl-3-methoxypyrazine, 2,3-diethyl-5-methylpyrazine, pyridine, 3-(methylthio)butanal, 2,5-dimethyl pyrazine, 2 methyl tetrahydrofuran-3-one, 2 ethyl 3 methylpyrazine, 2 methylpyrazine and bell pepper pyrazine (3-isolbutyl-2-methoxypyrazine), 1,2-Cyclopentanedione 3-methyl-; 1H-Pyrrole, 1-(2-furanylmethyl)-; 1H-Pyrrole, 1-methyl-; 1H-Pyrrole, 1-pentyl-; 1-Hydroxy-2-butanone; 2(3H)-Furanone, 5-acetyldihydro-; 2(5H)-Furanone; 2-Acetyl-3-methylpyrazine; 2-Acetyl-5-methylfuran; 2-Butenoic acid, 3-methyl-; 2-Cyclopenten-1-one, 3-ethyl-2-hydroxy-; 2-Furanmethanol, propanoate; 2-Hydroxy-3-pentanone; 2-n-Butyl furan; 2-Propanone, 1-hydroxy-; 2-Thiophenemethanol; 3(2H)-Thiophenone, dihydro-2-methyl-; 3-Thiophenecarboxaldehyde; Acetoin; Acetone; Acetylpyrazine; Butyrolactone; Ethanone, 1-(1H-pyrrol-2-yl)-; Ethanone, 1-(1-methyl-1H-pyrrol-2-yl)-; Ethanone, 1-(2-pyridinyl)-; Furan, 2-(2-furanylmethyl)-5-methyl-; Furan, 2,2′-methylenebis-; Furan, 2-[(methylthio)methyl]-; Furan, 2-methyl-; Furan, 4,5-diethyl-2,3-dihydro-2,3-dimethyl-; Propanoic acid; Pyrazine; Pyrazine, 2,6-dimethyl-; Pyrazine, ethyl-; Pyridine, 3-ethyl-; Pyridine, 3-methyl-; Pyrrole; 1H-Pyrrole-2-carboxaldehyde; 1H-Pyrrole-2-carboxaldehyde, 1-methyl-; 2-Butanone, 1-(acetyloxy)-; 2-Furancarboxaldehyde, 5-methyl-; 2-Furanmethanol; 2-Furanmethanol, acetate; 2-Propanone, 1-hydroxy-; Acetaldehyde; Acetoin; Butyrolactone; Ethanone, 1-(2-furanyl)-; Furan, 2-methyl-; Furfural; Pyrazine, 2,6-dimethyl-; Pyrazine, 3-ethyl-2,5-dimethyl-; Pyrazine, ethyl-.

As mentioned above, also descried herein are methods of forming a coffee-like beverage. For example, a method may include: preparing an unfermented plant-based formulation combining roasted and unroasted dry, plant-based ingredients; fermenting a plant-based fermentation substrate after combining with one or more one or more microorganism strains or a consortium of microorganisms; combining the unfermented plant-based formulation with a fermented fermentation substrate comprising one or both of a fermentation solid and/or a fermentation liquid extract of the fermented fermentation substrate so that the fermented fermentation substrate is included at between about 1% and 80% of the weight of the plant-based formulation to form a mixture; and drying the mixture to form grounds for a coffee substitute beverage or brewing the mixture to form the coffee substitute beverage.

The one or more one or more microorganism strains or a consortium of microorganisms may be selected from the group consisting of: Lactobacillus lactis, Lactobacillus plantarum, Bacillus subtilis, Rhizopus oligosporus, Pichia fermentans, Torulaspora delbrueckii, Saccharomyces cerevisiae, Pichia guilliermondii, Leuconostoc mesenteroides, Lactobacillus paracasei, Lactobacillus acidophilus, Lactobacillus bulgaricus, Lactobacillus helveticus, Acetobacter spp., Gluconobacter spp., and Lachancea thermotolerans.

In any of these examples preparing the mixture of an unfermented plant-based formulation may comprise combining roasted and unroasted dry ingredients. Preparing the mixture of an unfermented plant-based formulation may comprise combining two or more of: between about 5%-50% w/w ground chicory, between about 5%-25% w/w ground sunflower seeds, between about 5%-30% w/w ground lentil, between about 2%-20% w/w malt or malt extract, between about 5%-60% w/w date seeds, between about 0.1%-25% w/w grape seeds or grape seed extract, between about 1%-20% cinchona bark, between about 0.1%-5% dandelion, between about 0.1%-5% wormwood, between about 3.5%-5% w/w of guarana extract, between about 0.01-0.62% pure caffeine, between about 0.1%-25% w/w carob kibbles or pods or grounds or extract, and/or between about 0.05%-3% organic acids including but not limited to chlorogenic acid (CGA), citric, malic, tartaric, fumaric, valeric, butyric, formic and propionic acids.

In any of these methods the fermented substrate may comprises one or more of: fermented de-pitted coffee cherry fruits, fermented coffee pulp, fermented carob, fermented oats, fermented oat malt, fermented malt extract, fermented pomegranate pomace or its extract, fermented date seeds, fermented chicory, fermented figs, fermented sunflower seeds, fermented citrus fruit peel, and fermented fenugreek. Fermenting the plant-based fermentation substrate may comprise adding a starter culture comprising the one or more microorganism strains or a consortium of microorganisms to the plant-based fermentation substrate comprising one or more of de-pitted coffee cherry fruits, coffee pulp, carob, oats, oat malt, malt extract, and fenugreek, wherein the starter culture the cell density range from 105 to 108 CFU/mL; and fermenting the plant-based fermentation substrate and the one or more microorganism strains or a consortium of microorganisms.

Any of these methods may include adding one or more of: sugar substitutes and organic acids to the mixture of starter culture and the plant-based fermentation substrate. Any of these methods may include adding one or more of: a phosphate, and a phosphate analogue to the mixture of starter culture and the plant-based fermentation substrate. Fermenting the plant-based fermentation substrate may proceed for at least 0.5-3 days at between about 28 degrees C. to 37 degrees C. In some examples fermenting the plant-based fermentation substrate fermentation proceeds for at least 5 days at 25 degrees C. or more. In some examples fermenting the plant-based fermentation substrate proceeds for at least 7 days at room temperature.

Any of these methods may include processing the fermented fermentation substrate by separating liquid from solid material by one or more of: filtration, pressing, oven drying, air drying, forced-air drying, or vacuum drying. For example, the methods described herein may include obtaining, from the liquid material, dried fermented solids with a final moisture content of less than 10% w/w. Any of these methods may include drying the fermented solids by one or more of: filtration, pressing, oven drying, air drying, forced-air drying, or vacuum drying to a final moisture content of 10% w/w. Combining the unfermented plant-based formulation with the fermented fermentation substrate comprises adding both the dried fermented solid and the fermentation liquid extract.

As mentioned, the chlorogenic acid may be recombinant chlorogenic acid; the malt extract may be one or more of rice malt, oat malt, barley malt, corn malt, millet malt and coffee malt. The ground sunflower may be roasted between about 180 and 200 degrees C. The ground carob may be roasted. The unfermented plant-based formulation may further comprise about 6%-16% w/w of ground roasted fenugreek. The unfermented plant-based formulation may further comprise one or more of: between about 6%-16% w/w of ground fenugreek, between about 0.2%-1% w/w quinic acid, between about 4%-8% w/w of ground tomato flakes, between about 5%-11% w/w ground pumpkin seed; between about 0.5%-2% w/w yeast; and between about 0.1%-0.5% w/w ground juniper berries. The unfermented plant-based formulation may further comprise one or more of ground, powdered or dehydrated: acorn, asparagus seed, barley, buckwheat, black eyed peas, burdock, Cabernet Sauvignon wine, flour, caffeine, carrots, chana dal chickpeas, chocolate, cocoa, cacao, cinnamon, citric acid, coriander seeds, corn, cranberry seeds, dandelion root, dried tomato flakes, fenugreek, figs, rice, grape seed extract, green split peas, guarana extract, juniper berries, lentils, mango, mesquite, caramel millet, chocolate pale malt, coffee malt, Reishi mushrooms, oats, okra, orange peel, mushrooms, orange peel, pale corn, pumpkin seeds, quinic acid, ramon seeds, raspberry seeds, rye, Saborizante Artificial, Sacha inchi seeds, soybeans, strawberry Seeds, sugar beets, tamarind seeds, turmeric, and yeast.

The unfermented plant-based formulation may be configured (e.g., by selecting, filtering, etc.) to have a median particle size in the range of 200-1500 micrometers. For example, the unfermented plant-based formulation may have a median particle size in the range of 200-1500 micrometers and at least 85% by weight of said plant-based formulation has a particle size in the range of 200-1000 micrometers. The unfermented plant-based formulation may comprise melanoidins by at least 5% by weight. The unfermented plant-based formulation may contain chlorogenic acid at a concentration of at least 0.9% by weight.

Any of these methods may include packaging the resulting product. For example any of these methods may include sealing the composition within one or more of: a foil package, a water-permeable bag, a jar or a canister.

These methods may include adding between about 0.1 and 3% w/w of one or more of: Guaiacol, 4-ethylguaiacol, 4-vinylguaiacol, 3-mercapto-3-methylbutylformate, 2-furfurylthiol, Furaneol, 2,3-pentanedione, 3-methylbutanoic acid, 3-methybutanal, P-cresol, 2,3-dimethylpyrazine, 2-methylbutanal, 2-methylpropanal, Maltol, Phenylacetaldehyde, Phenylacetic acid, Linalool, Damascenone, 2-ethyl-3,5 dimethyl pyrazine, 2 ethyl 5(6) methyl pyrazine, 2-acetyl-1-methylpyrrole, EHMF (5-Ethyl-3-hydroxy-4-methyl-2(5H)-furanone), 2-isolbutyl-3-methoxypyrazine, 2-sec-butyl-3-methoxypyrazine, 2,3-diethyl-5-methylpyrazine, pyridine, 3-(methylthio)butanal, 2,5-dimethyl pyrazine, 2 methyl tetrahydrofuran-3-one, 2 ethyl 3 methylpyrazine, 2 methylpyrazine and bell pepper pyrazine (3-isolbutyl-2-methoxypyrazine), 1,2-Cyclopentanedione 3-methyl-; 1H-Pyrrole, 1-(2-furanylmethyl)-; 1H-Pyrrole, 1-methyl-; 1H-Pyrrole, 1-pentyl-; 1-Hydroxy-2-butanone; 2(3H)-Furanone, 5-acetyldihydro-; 2(5H)-Furanone; 2-Acetyl-3-methylpyrazine; 2-Acetyl-5-methylfuran; 2-Butenoic acid, 3-methyl-; 2-Cyclopenten-1-one, 3-ethyl-2-hydroxy-; 2-Furanmethanol, propanoate; 2-Hydroxy-3-pentanone; 2-n-Butyl furan; 2-Propanone, 1-hydroxy-; 2-Thiophenemethanol; 3(2H)-Thiophenone, dihydro-2-methyl-; 3-Thiophenecarboxaldehyde; Acetoin; Acetone; Acetylpyrazine; Butyrolactone; Ethanone, 1-(1H-pyrrol-2-yl)-; Ethanone, 1-(1-methyl-1H-pyrrol-2-yl)-; Ethanone, 1-(2-pyridinyl)-; Furan, 2-(2-furanylmethyl)-5-methyl-; Furan, 2,2′-methylenebis-; Furan, 2-[(methylthio)methyl]-; Furan, 2-methyl-; Furan, 4,5-diethyl-2,3-dihydro-2,3-dimethyl-; Propanoic acid; Pyrazine; Pyrazine, 2,6-dimethyl-; Pyrazine, ethyl-; Pyridine, 3-ethyl-; Pyridine, 3-methyl-; Pyrrole; 1H-Pyrrole-2-carboxaldehyde; 1H-Pyrrole-2-carboxaldehyde, 1-methyl-; 2-Butanone, 1-(acetyloxy)-; 2-Furancarboxaldehyde, 5-methyl-; 2-Furanmethanol; 2-Furanmethanol, acetate; 2-Propanone, 1-hydroxy-; Acetaldehyde; Acetoin; Butyrolactone; Ethanone, 1-(2-furanyl)-; Furan, 2-methyl-; Furfural; Pyrazine, 2,6-dimethyl-; Pyrazine, 3-ethyl-2,5-dimethyl-; Pyrazine, ethyl- to the unfermented plant-based mixture.

Brewing the mixture to form the coffee substitute beverage may comprise adding water at 200 degrees F. (93 degrees C.) or greater (e.g., 205 degrees F. or greater, 210 degrees F. or greater, etc.) to the composition, steeping, and decanting.

In any of these methods, brewing the mixture to form the coffee substitute beverage may comprise cold brewing the mixture by adding water to the composition in a ratio of greater than 1:4 (mixture:water, e.g., 1:5, 1:6, etc.) at 25 degrees C. or lower, mixing and steeping for between 0.5-18 hours at 4 degrees C. and filtering.

All of the methods and apparatuses described herein, in any combination, are herein contemplated and can be used to achieve the benefits as described herein.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIG. 1 schematically illustrates the components of the coffee substitute beverage as described herein.

FIG. 2 schematically illustrates one example of a method of forming a coffee substitute beverage as described herein.

### DETAILED DESCRIPTION

Described herein are novel compositions for forming brewed coffee-like beverages, as well as methods of making them and methods of brewing coffee-like beverages from these compositions. The coffee-like beverages described herein may be coffee substitutes sharing very similar flavor profiles as coffee, but may be made using sustainable materials and techniques. In general, these methods may include forming a mixture of particular grains, seeds, nuts, roots and other plant-based ingredients (“plant-based formula”), which may be roasted and whole or ground within a particular particle size. These components may be further combined with a fermented (plant-based) substrate material. The fermented substrate may be added as either or both a dried solid material from the fermented substrate and/or a liquid portion of the fermented substrate. In some examples one or more additional flavor components may be added.

The plant-based formula may particularly include roasted and ground chicory, roasted and ground sunflower seeds, roasted and ground lentils, malts, date seeds, grape seeds or its extract, cinchona bark, dandelion, wormwood, guarana extract or pure caffeine, roasted and ground carob or kibbles or pods or their extract, and organic acids including but not limited to chlorogenic acid (CGA), citric, malic, tartaric, fumaric, valeric, butyric, formic and/or propionic acids The addition of fermented substrate such as fermented de-pitted coffee cherry fruits, fermented coffee pulp, fermented carob, fermented oats, fermented oat malt, fermented malt extract, fermented pomegranate pomace or its extract, fermented date seeds, fermented chicory, fermented figs, fermented sunflower seeds, fermented citrus fruit peel, and fermented fenugreek within specified ranges (as described herein) may result in a beverage that has a pleasing profile that is remarkably complex and pleasing to taste, similar to coffee.

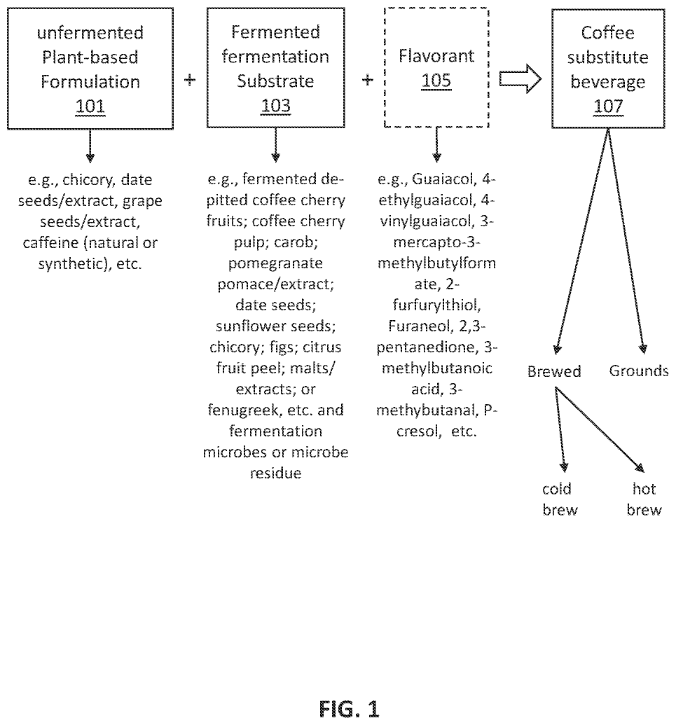

For example, FIG. 1 schematically illustrates one example of a composition that forms a coffee-like beverage. This coffee substitute beverage composition 107 includes a mixture of a plant-based formulation 101 and a fermented fermentation substrate 103. One or more additional components may also or alternatively be included, such as additional flavors (e.g., natural flavor blends/flavor enhancers) and/or supplements (e.g., caffeine, etc.) 105. In some cases the plant-based formulation is unfermented. The fermented fermentation substrate may be included at between about 1% and 80% of the weight of the plant-based formulation (e.g., between about 1%-70%, between about 1%-75%, between about 1%-65%, between about 1%-60%, between about 1%-55%, between about 1%-50%, etc.). The fermented fermentation substrate may comprises one or more of: fermented de-pitted coffee cherry fruits, fermented coffee pulp, fermented carob, fermented oats, fermented oat malt, fermented malt extract, fermented pomegranate pomace or its extract, fermented date seeds, fermented chicory, fermented figs, fermented sunflower seeds, fermented citrus fruit peel, and fermented fenugreek, further wherein the fermented fermentation substrate comprises one or both of a fermentation solid and/or a fermentation liquid extract of the fermented fermentation substrate.

Examples of flavorants/flavor enhancers 105 may include one or more of: natural coffee flavors, natural chocolate flavors, Guaiacol, 4-ethylguaiacol, 4-vinylguaiacol, 3-mercapto-3-methylbutylformate, 2-furfurylthiol, Furaneol, 2,3-pentanedione, 3-methylbutanoic acid, 3-methybutanal, P-cresol, 2,3-dimethylpyrazine, 2-methylbutanal, 2-methylpropanal, Maltol, Phenylacetaldehyde, Phenylacetic acid, Linalool, Damascenone, 2-ethyl-3,5 dimethyl pyrazine, 2 ethyl 5(6) methyl pyrazine, 2-acetyl-1-methylpyrrole, EHMF (5-Ethyl-3-hydroxy-4-methyl-2(5H)-furanone), 2-isolbutyl-3-methoxypyrazine, 2-sec-butyl-3-methoxypyrazine, 2,3-diethyl-5-methylpyrazine, pyridine, 3-(methylthio)butanal, 2,5-dimethyl pyrazine, 2 methyl tetrahydrofuran-3-one, 2 ethyl 3 methylpyrazine, 2 methylpyrazine and bell pepper pyrazine (3-isolbutyl-2-methoxypyrazine), 1,2-Cyclopentanedione 3-methyl-; 1H-Pyrrole, 1-(2-furanylmethyl)-; 1H-Pyrrole, 1-methyl-; 1H-Pyrrole, 1-pentyl-; 1-Hydroxy-2-butanone; 2(3H)-Furanone, 5-acetyldihydro-; 2(5H)-Furanone; 2-Acetyl-3-methylpyrazine; 2-Acetyl-5-methylfuran; 2-Butenoic acid, 3-methyl-; 2-Cyclopenten-1-one, 3-ethyl-2-hydroxy-; 2-Furanmethanol, propanoate; 2-Hydroxy-3-pentanone; 2-n-Butyl furan; 2-Propanone, 1-hydroxy-; 2-Thiophenemethanol; 3(2H)-Thiophenone, dihydro-2-methyl-; 3-Thiophenecarboxaldehyde; Acetoin; Acetone; Acetylpyrazine; Butyrolactone; Ethanone, 1-(1H-pyrrol-2-yl)-; Ethanone, 1-(1-methyl-1H-pyrrol-2-yl)-; Ethanone, 1-(2-pyridinyl)-; Furan, 2-(2-furanylmethyl)-5-methyl-; Furan, 2,2′-methylenebis-; Furan, 2-[(methylthio)methyl]-; Furan, 2-methyl-; Furan, 4,5-diethyl-2,3-dihydro-2,3-dimethyl-; Propanoic acid; Pyrazine; Pyrazine, 2,6-dimethyl-; Pyrazine, ethyl-; Pyridine, 3-ethyl-; Pyridine, 3-methyl-; Pyrrole; 1H-Pyrrole-2-carboxaldehyde; 1H-Pyrrole-2-carboxaldehyde, 1-methyl-; 2-Butanone, 1-(acetyloxy)-; 2-Furancarboxaldehyde, 5-methyl-; 2-Furanmethanol; 2-Furanmethanol, acetate; 2-Propanone, 1-hydroxy-; Acetaldehyde; Acetoin; Butyrolactone; Ethanone, 1-(2-furanyl)-; Furan, 2-methyl-; Furfural; Pyrazine, 2,6-dimethyl-; Pyrazine, 3-ethyl-2,5-dimethyl-; Pyrazine, ethyl- etc.

As described in greater detail below, the coffee substitute beverage 107 may be compounded as a brewed beverage (e.g., cold or hot brewed) and/or as grounds (e.g., “coffee substitute beverage grounds”) that may be brewed later. The grounds may be formulated so that the beverage may be brewed as a traditional coffee brewing, or in a tea-bag like configuration.

The plant-based formulation may include, for example: between about 5%-50% w/w ground chicory, between about 5%-60% w/w date seeds, between about 0.1%-25% w/w grape seeds or grape seed extract, and between about 0.01-0.62% caffeine. In some examples the fermented fermentation substrate comprises a fermentation liquid extract comprising water-soluble metabolites of the fermented fermentation substrate. The plant-based formulation may include one or more of: ground sunflower seeds, ground lentil, malt or malt extract, cinchona bark, dandelion, wormwood, guarana extract, carob kibbles or pods or grounds or extract, and/or organic acids including but not limited to chlorogenic acid (CGA), citric, malic, tartaric, fumaric, valeric, butyric, formic and propionic acids.

The fermented fermentation substrate may include residual fermentation microbial remains of one or more of: Pichia fermentans, Pichia guilliermondii, Torulaspora delbrueckii, Saccharomyces cerevisiae, Lactobacillus plantarum, Lactococcus lactis, Rhizopus oligosporus, Candida parapsilosis, and Pichia kluyveri. The fermented fermentation substrate may comprises one or more of: fermented de-pitted coffee cherry fruits, fermented coffee cherry pulp, fermented carob, fermented pomegranate pomace or pomegranate pomace extract, fermented date seeds, fermented sunflower seeds, fermented chicory, fermented figs, fermented citrus fruit peel, fermented malt or malt extract, and fermented fenugreek which has been fermented with one or more of: Pichia fermentans, Pichia guilliermondii, Torulaspora delbrueckii, Saccharomyces cerevisiae, Lactobacillus plantarum, Lactococcus lactis, Rhizopus oligosporus, Candida pxarapsilosis, Pichia kluyveri, Leuconostoc mesenieroides, Lactobacillus paracasei, Lactobacilius acidophilus, Lactobacillus bulgaricus, Lactobacillus helveticus, Acetobacter spp., Gluconobacter spp., and Lachancea thermotolerans.

In one example, a composition as described herein may include a plant-based formulation including: Roasted Chicory (e.g., between 30%-40%), Roasted Sunflower Seeds (between 0% and 12%), Lentils roasted (between 0%-12%), Roasted Date Seeds (between 20%-50%), Dandelion root roasted (between 0%-1%), Caramel 240 L Millet Malt (between 0%-12%), Pale Corn malt 180 (between 0%-5%), Roasted Carob (between 0%-8%), Roasted Grapeseeds (between 2%-18%), Caffeine (between 0.2% to 0.5%), C-CB3 (e.g., natural flavors, 3-methylbutanoic acid, 2,3-pentanedione and 2-methylpropanal, between 0%-0.5%), C-CB4 (e.g., natural flavors, 2-furfurylthiol, 2 ethyl-3,5-dimethyl pyrazine and 2-ethyl-5-methyl pyrazine, between 0% to 0.5%), and X3.2 (e.g., 2-ethyl-5(6) methylpyrazine, Furfurylthiol, 2-acetyl-1-methylpyrrole undiluted, 2,3 pentanedione, linalool undiluted, 4 ethylguaiacol, EHMF (5-Ethyl-3-hydroxy-4-methyl-2(5H)-furanone), 2-sec-butyl-3-methoxypyrazine, 2,3 diethyl 5 methylpyrazine, Pyridine, 2 ethyl 3,5 dimethylpyrazine, 3(methylthio)butanal, 2-isobutyl 3 methoxypyrazine, 2,5 dimethylpyrazine, 2-methylpropanal, 3methylbutanoic acid, 2 methyl tetrahydrofuran-3-one, 2 methylbutyraldehyde, 2-ethyl-3-methylpyrazine, 2-methylpyrazine, between about 0%-0.6%), wherein 0% indicates that the component may be absent.

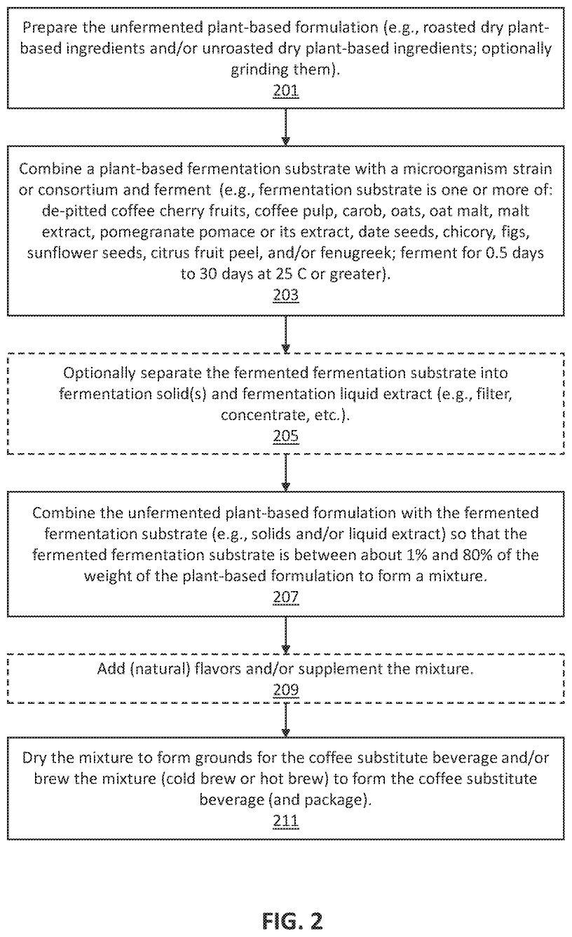

FIG. 2 illustrate one example of a method of forming a coffee-like beverage as described herein. For example, any of these methods may include: preparing an unfermented plant-based formulation combining roasted and unroasted dry, plant-based ingredients 201. For example, these ingredients may be ground separately or together. The fermentation substrate may then be prepared (or may be prepared prior to preparing the unfermented plant-based formulation) 203. The plant-based fermentation substrate may be combined with one or more microorganism strains or a consortium of microorganisms.

Optionally the fermented fermentation substrate 205 may be divided up into solid (fermentation solids) and liquid (e.g., fermentation extract).

Any of these methods may also include combining the unfermented plant-based formulation with a fermented fermentation substrate comprising one or both of a fermentation solid and/or a fermentation liquid extract of the fermented fermentation substrate so that the fermented fermentation substrate is included at between about 1% and 80% of the weight of the plant-based formulation to form a mixture 207. Optionally, one or more additional materials (e.g., flavorants, colorants, fortifying compositions, etc.) may be added 209.

Any of these methods and apparatuses may be configured to dry the mixture to form grounds for a coffee substitute beverage or brewing the mixture to form the coffee substitute beverage 211. In general, preparing the mixture of an unfermented plant-based formulation may include combining roasted and unroasted dry ingredients. Preparing the mixture of an unfermented plant-based formulation comprises combining two or more of: between about 5%-50% w/w ground chicory, between about 5%-25% w/w ground sunflower seeds, between about 5%-30% w/w ground lentil, between about 2%-20% w/w malt or malt extract, between about 5%-60% w/w date seeds, between about 0.1%-25% w/w grape seeds or grape seed extract, between about 1%-20% cinchona bark, between about 0.1%-5% dandelion, between about 0.1%-5% wormwood, between about 3.5%-5% w/w of guarana extract, between about 0.01-0.62% pure caffeine, between about 0.1%-25% w/w carob kibbles or pods or grounds or extract, and/or between about 0.05%-3% organic acids including but not limited to chlorogenic acid (CGA), citric, malic, tartaric, fumaric, valeric, butyric, formic and propionic acids.

### Example 1. Hot Brew Coffee Substitute Beverage Production

This example describes a mixture of plant-based ingredients, fermented plant-based ingredients, and pure compounds that can reproduce the characteristic aroma and flavor of coffee beverages. The composition and methods to elaborate this coffee alternative are presented below.

The coffee substitute beverage is prepared in five steps: (1) Preparation and mixture of grains, seeds, and other plant-based ingredients (“plant-based base formula” or “base formula”); (2) Fermentation of a substrate with a microorganism and addition of liquid and/or solid phase to the base formula; (3) Addition of food grade flavor compounds to the base formula; (4) Addition of chlorogenic acid (CGA); and (5) Preparation of the brewed coffee substitute beverage by the French press method.

### Step 1.1: Preparation of a Plant-Based Base Formula

Plant-based ingredients were mixed as described in Table 1. Some ingredients were roasted prior to addition to the mixture. For this procedure, 200 g of the desired ingredient was roasted in the Hottop KN-8828B-2K+ roaster, the roasting process monitored, and the product released once the roasting temperature of the ingredient was achieved. The same procedure was conducted with each ingredient to be roasted. The roasted ingredients were allowed to cool down to room temperature before use in the formula.

Dry and whole ingredients were ground (except for powders and flavor compounds) in the Baratza Encore grinder at a setting of 30, to a medium-coarse particle size.

TABLE 1

| | Percentage (%) |
|---|---|
| | of ingredient |
| | in plant-based |
| Ingredients | formula |
| Chicory | 29.27 |
| Sunflower Seeds | 11.98 |
| Lentils | 15.63 |
| Millet Malt | 10.42 |
| Guarana extract | 4.63 |
| Carob | 4.17 |
| Chlorogenic acid (CGA) | 0.99 |
| Tomato flakes | 4.79 |
| Quinic acid | 0.42 |
| Pumpkin seeds | 5.21 |
| Fenugreek | 8.33 |
| Yeast | 1.56 |

### Step 1.2: Fermentation Processing and Post-Processing

Yeast strains listed herein were obtained and grown in basic YPD media for 4 days at 27 degrees C. The starter inoculum was added at a final concentration of 1%% v/v. Fermentation was carried out for 48 hours at a constant temperature of 30 degrees C.

After 48 hours, the fermented solids (e.g. carob, de-pitted coffee cherry fruits) were separated from the liquid. The fermentation medium was thus split into two phases: a solid fermented substrate (e.g. carob, de-pitted coffee cherry fruits) and a liquid phase (fermentation liquid).

Dried solids were transferred to a dehydrator (Presto 06300 Dehydro Electric Food Dehydrator) with a non-stick mesh screen and allowed to dry for a period of 1.5 hours at 65 degrees C. to reach a moisture % of <3% w/w.

The dry fermentation solid phase was supplemented in the mixture of plant based ingredients at 3-5% w.w (if carob) or 10-20% w/w (if coffee pulp) in a 100 g formula. The liquid fermentation output was used at 0.5-1.25% w/w in the formula.

### Step 1.3; Addition of Chemical Compounds.

A flavor blend was prepared using natural coffee and chocolate flavors making 41.38% of the blend and remaining 58.62% comprising of guaiacol, 4-hydroxy-2,5-dimethyl-3(2H)-furanone, 2-furfurylthiol, 3-mercapto-3-methylbutylformate, 4-ethylguaiacol, 4-vinylguaiacol, Beta-damascenone, Phenylacetaldehyde, 2,3-butanedione For every 93.7 g of base formula, 2.42 g of this liquid flavor blend was added and allowed to absorb for 15-30 minutes into the mixture comprising the base formula and fermentation products described in Step 1.2.

Optionally, one or more additional materials (e.g., flavorants, colorants, fortifying compositions, etc.) may be added 205.

Food-grade chlorogenic acid (CGA) was obtained from a sustainable source at a purity exceeding 90%. This chlorogenic acid is supplemented in at least 0.01%, at least 0.02% at least 0.03%, at least 0.04%, at least 0.05%, at least 0.06%, at least 0.07%, at least 0.08%, at least 0.09%, or at least 0.1% w/w in the mixture described in step 1.3 containing base formula, fermentation products, and pure flavor compounds. After addition of purified chlorogenic acid, this mixture represents the “complete formula”.

### Brewing Process of the Coffee Substitute Beverage

The coffee substitute beverage is brewed by the French press method by adding hot water (205 degrees Fahrenheit) to the complete formula described in Step 1.4 at 1:12, 1:15 or 1:17 w/w (complete formula:water ratio), steeping for 4 minutes, and decanting the liquid into a glass for tasting. Control beverages were prepared from ground coffee beans using the same method.

The resulting brewed coffee substitute beverages were evaluated by a panel of trained taste testers. Panelists were asked to evaluate each sample in categories including but not limited to: aroma, flavor, aftertaste, acidity, mouthfeel, and similarity to brewed coffee. Each category was quantified on a scale from 1-10 with 1=dislike extremely/extremely dissimilar to brewed coffee to 10=like extremely/extremely similar to brewed coffee. Panelists also recorded qualitative impressions for each sample, when appropriate, with e.g. descriptors indicating similarity to other food items; floral character; fruity character; chocolate character; sweetness; nuttiness; grain & cereal character; roast character; spice character; savoriness; vegetal, earthy, and/or herbal character; etc.

### Example 2. Cold Brew Coffee Substitute Beverage Production

This example is a mix of plant-based ingredients, fermented plant-based ingredients, and pure compounds that can reproduce the characteristic aroma and flavor of cold brew coffee beverages. The composition and methods to elaborate this cold brew coffee alternative are presented below.

The cold brew coffee substitute beverage is prepared in six steps: (1) Preparation and mixture of grains, seeds, and other plant-based ingredients (“plant-based base formula” or “base formula”); (2) Fermentation of a substrate with a microorganism and addition of liquid and/or solid phase to the base formula; (3) Addition of food grade flavor compounds to the base formula; (4) Optional addition of chlorogenic acid; (5) Preparation of the brewed coffee substitute beverage by traditional steeping or vacuum based method; (6) Filtration of the cold brew coffee substitute beverage; (7) Optional dilution of brewed coffee substitute concentrate with cold filtered water.

### Step, 2.1: Preparation of a Plant-Based Base Formula

Plant-based ingredients used in the cold brew alternative formula were weighed as described in Table 1. Some ingredients were roasted prior to addition to the mixture. Roasting was conducted as described earlier in Example 1 of the hot brew method. Dry and whole ingredients were ground (except for powders and flavor compounds) in the Baratza Encore grinder at to a coarse particle size.

TABLE 2
Base formula to create a cold brew substitute beverage

| | Percentage (%) |
|---|---|
| | of ingredient |
| | in plant-based |
| Ingredients | formula |
| Chicory | 29.73 |
| Sunflower Seeds | 6.87 |
| Lentils | 21.10 |
| Caramel 240 L Millet Malt | 7.33 |
| Fenugreek | 13.92 |
| Guarana extract | 4.12 |
| Juniper berries | 0.32 |
| Pale Corn malt | 6.42 |
| Carob | 10.08 |
| Malic Acid | 0.09 |
| Natural flavors blend | 2.46 |
| TOTAL | 100.00 |

natural flavors blend=40.66% Natural flavors (Fruity+Chocolate)+59.34% of pure natural compounds of Guaiacol, 4-hydroxy-2,5-dimethyl-3(2H)-furanone, 2-furfurylthiol, 3-mercapto-3-methylbutylformate, 4-ethylguaiacol, 4-vinylguaiacol, Beta-damascenone, Phenylacetaldehyde, 2,3-butanedione

### Step 2.2: Fermentation Processing and Post-Processing.

Yeast strains listed in claim 1 were obtained and grown in basic YPD for 4 days at 27 degrees C. The cultures were centrifuged, and the pellet was then used as a starter inoculum after resuspension in water.

The starter inoculum was added at a final concentration of 10% v/v. Fermentation was carried out for 48 hours at a constant temperature of 30 degrees C.

After 48 hours, the fermented solids (e.g. carob, de-pitted coffee cherry fruits) were dried, leaving no fermentation liquid. The fermentation medium was thus split into two phases: a solid fermented substrate (e.g. carob, de-pitted coffee cherry fruits) and a liquid phase (fermentation liquid). The liquid phase was filtered and stored.

The dry fermentation solid phase was supplemented in the mixture of plant based ingredients at 3-20% in a 100 g formula. The liquid fermentation output was used at 2.5% w/w in the formula.

### Step 2.3: Addition of Food Grade Flavor Compounds to the Base Formula

A flavor blend was prepared using natural flavors and pure natural flavor compounds as shown in Table 2. For every 93.7 g of base formula, 2.42 g of this liquid flavor blend was added and allowed to absorb for 15-30 minutes into the mixture comprising the base formula and fermentation products described in Step 1.2.

A flavor blend was mixed using natural flavors and pure natural flavor compounds in ratios discussed as in step 2.1. For every 97.6 g of base formula, 2.40 g of this liquid flavor blend was added and allowed to absorb for 15-30 minutes into the mixture comprising the base formula and fermentation products described in Step 2.2.

### Step 2.4: Optional Addition of Chlorogenic Acid

Food-grade chlorogenic acid (CGA) is obtained from a sustainable source at a purity exceeding 90%. This chlorogenic acid is supplemented in at least 0.01%, at least 0.02% at least 0.03%, at least 0.04%, at least 0.05%, at least 0.06%, at least 0.07%, at least 0.08%, at least 0.09%, or at least 0.1% w/w in the mixture described in step 2.3 containing base formula, fermentation products, and pure flavor compounds. After addition of purified chlorogenic acid, this mixture represents the “complete formula”.

### Step 2.5: Preparation of the Brewed Coffee Substitute Beverage by Traditional Steeping or Vacuum Based Method

Cold brewed coffee substitute beverage is optionally prepared using the traditional steeping method. Briefly, the complete formula described in step 2.4 is transferred to a container, and a 1:5 ratio (w/w, ingredients:water) of filtered water at 22 degrees C. is added. The container is sealed and briefly mixed. The ingredients are allowed to steep for 18 hours at 4 degrees C.

Cold brewed coffee substitute beverage is optionally prepared by the vacuum based method using a FrankOne device. The complete formula described in step 2.4 is added on top of the sealed filter and 1:12 of filtered room temperature water is added and allowed to steep at room temperature on the FrankOne for 4 minutes. After 4 minutes, the grounds are gently swirled with a spoon and the release button is pressed for the vacuum to filter the coffee substitute beverage.

### Step 2.6: Filtering of the Brewed Coffee Substitute Beverage by Using Different Micron Size Filters

Cold brewed coffee described in Step 2.5 is filtered. After 18 hours of steeping, the container is removed from 4 degrees C. storage and all of the contents filtered through 10 micron to 115 microns mesh. The grounds are lightly pressed and swirled to facilitate filtration.

Alternatively, cold brewed coffee is filtered using a V60 Hario paper filter or a #2 paper filter (bleached). Alternatively, a vacuum pump may be used to facilitate filtration.

The product of filtration is referred to as the cold brewed coffee substitute concentrate.

Step 2.7: Diluting Brewed Coffee Substitute Concentrate with Cold Filtered Water

To obtain the final cold brewed coffee substitute beverage, the concentrate described in step 2.6 is diluted with water. Dilution ratios (concentrate:water v/v) vary from 1:10 to 10:1. After dilution, the final cold brewed coffee substitute beverage is stored at 4 degrees C. for at least 3 hours before tasting. The final cold brewed coffee substitute beverage can be stored at 4 degrees C. for up to 10 days.

### Example 3. Development of a Base Formula of Plant-Derived Ingredients Yields Brewed Coffee Substitute Beverage with 80% Similarity to Brewed Coffee

Brewed coffee substitute beverages were prepared by the French press method of adding hot water (205 degrees F.) to mixtures of plant-derived ingredients at 1:12.5 (ground:water ratio) (Table 3), steeping for 4 minutes, and decanting the liquid into a glass for tasting. Control beverages were prepared from ground coffee beans using the same method.

The resulting brewed coffee substitute beverages were evaluated by a panel of trained taste testers. Panelists were asked to evaluate each sample in categories including but not limited to: aroma, flavor, aftertaste, acidity, mouthfeel, and similarity to brewed coffee. Each category was quantified on a scale from 1-10 with 1=dislike extremely/extremely dissimilar to brewed coffee to 10=like extremely/extremely similar to brewed coffee. Panelists also recorded qualitative impressions for each sample, when appropriate, with e.g. descriptors indicating similarity to other food items; floral character; fruity character; chocolate character; sweetness, nuttiness; grain & cereal character; roast character; spice character; savoriness; vegetal, earthy, and/or herbal character; etc.

Plant base formulas containing chicory root yielded brewed coffee substitute beverages that received high average scores from panelists in all categories, including 8/10 in similarity to brewed coffee.

TABLE 3

| | | Similarity | |
|---|---|---|---|
| | | to brewed | Qualitative |
| Number | Ingredients | coffee | impressions |
| 1 | chicory + dandelion + sunflower | 7 | n/a |
| | seeds | | |
| 2 | malted barley + roasted barley + | 8 | Roasted, |
| | James brown rice + oat malt + | | not burnt; |
| | lentils, + dandelion root + roasted | | fruity; |
| | carob, + chicory + mango + orange | | tea-like |
| | peel, + reichi mushroom + | | |
| | pumpkin seeds + strawberry + | | |
| | grape seeds + ground cinnamon | | |

### Example 4. Carob Fermented with Yeast Yields Solid and Liquid Material with Fruit-Like Flavor Characteristics

This example describes the finding that dry and liquid material resulting from a fermentation of carob by various yeast strains had fruit-like flavor characteristics. The yeast strains (Table 4) were grown for 2 days in YPD medium at 28 degrees C.

Pellets of each strain were suspended in water to obtain starter inoculum. Yeast starter inoculum to a final concentration of 10% v/v was inoculated with the carob medium. Fermentation was carried out for 48 hours at 30 degrees C.

After fermentation, the fermented substrate was drained, and dried in a food dehydrator to <3% w/w. The fermentation liquid was filtered, and stored. The dry and liquid fermentation outputs were evaluated by a panel of taste testers to determine the aroma, flavor and other attributes.

Taste testers observed that the fermentation outputs expressed a variety of fruit-like flavor characteristics.

TABLE 4

| | Sample | Perceived | |
|---|---|---|---|
| Yeast strain | type | aroma | Perceived flavor |
| Pichia kluyveri | Solid | Grape, sweet | Very sour, grape, sweet, like a |
| | | | blueberry sourpatch, |
| | | | blueberry, blackberry |
| Pichia | Solid | Prune, figs | Sour, prune juice, medicinal, |
| fermentans | | | prune sweetness |
| Candida | Solid | Black tea | strong tea, iced tea, lemon, |
| parapsilosis | | | like a strong Lipton iced green |
| | | | tea |
| Saccharomyces | Solid | Grape, | Intensely bitter, fermented, |
| cerevisiae | | cherry soda | like pre-made beer, yeasty |
| Saccharomyces | Liquid | Fermented, | Sweet, watery, lemon, pear |
| cerevisiae | | peach, prune | |
| Candida | Liquid | n/a | Watery, lemon, ginger, tea- |
| parapsilosis | | | like |
| Pichia kluyveri | Liquid | Peach, | Cranberry, watery, nice |
| | | cherry juice | acidity at the end |
| Pichia | Liquid | Fruity | Loquat, dark fruit, |
| fermentans | | | ripe |
| Torula | Liquid | More | n/a |
| spora | | carob flavor | |

### Example 5. Addition of Fermented Material to Plant Base Formula or Resulting Beverage Improves Flavor of Beverage

This example describes the finding that adding fermentation outputs described in Example 4 either to the plant base formula or resulting beverage yielded coffee substitute beverages with improved flavors.

The addition of fermented liquid from coffee pulp and/or carob showed improved fruity flavor notes with incorporation to the ground coffee substitute in the brewing process. This is showcased in Table 5 with both coffee pulp and carob liquid ferments. When plant ingredients base formula (mixture of chicory+sunflower seeds+lentils+Millet malt+fenugreek seeds+guarana extract+juniper berries+corn malt+carob+CGA+tomto flakes+quinic acid+natural coffee and chocolate flavors was tasted by a coffee expert along with liquid fermentation outputs, the brew was described as a “better, balanced, body is closer, texturally way closer, bitterness closer to coffee (still lingers more than he'd like), sweeter, caramel popcorn, acidity (no specific citrus note, but pleasant), darker, no specific acidity or fruit notes”.

TABLE 5

| | | | V4.16 + | | | |
|---|---|---|---|---|---|---|
| | | | 0.25% | | | |
| | | | Carob - | | | |
| | | | Pichia | | V6.0+ | |
| | | | (liquid) + | V6.0 + 1% | 1.25% | |
| | | | 0.5% | Coffee | Coffee | V6.0 + 1% |
| | V4.11 + | V4.16 + | Coffee- | pulp - | pulp - | Carob - |
| | 1% Carob - | 1% Carob - | pulp - | Pichia | Pichia | Pichia |
| Sensory | Pichia | Pichia | Pichia | kluyveri | fermentans | fermentans |
| notes | (liquid) | (liquid) | (liquid) | (liquid) | (liquid) | (liquid) |
| Aroma | Sweet, | n/a | Better | Aroma is dark, roasted | | Caramel, |
| | roasted, | | flavor and | and similar to coffee; | | golden |
| | burnt; | | aroma than | | | syrup, |
| | | | the samples | | | green apple |
| | | | without | | | note, aroma |
| | | | fermentation; | | | is closest to |
| | | | darker; | | | coffee |
| | | | however | | | |
| | | | unable to | | | |
| | | | pinpoint to | | | |
| Flavor | sweet, | n/a | the fruit | great acidity and flavor; | | Caramel, |
| | under | | flavor | has some more umami | | golden |
| | extracted | | | flavor which can be | | syrup, nice |
| | with flavor | | | reduced | | clean finish, |
| | of juniper, | | | | | under |
| | good | | | | | extracted, |
| | mouthfeel | | | | | sour, better |
| | | | | | | acidity on |
| | | | | | | this one, |
| | | | | | | green apple |
| | | | | | | note (tart) |
| | | | | | | more like |
| | | | | | | malic acid |

Dry fermentation outputs from coffee pulp or carob also showed additional fruity flavor notes with incorporation to the ground coffee substitute in the brewing process. This is showcased in Table 6 with both dry coffee pulp and carob liquid fermentation outputs. With coffee pulp fermentation outputs, the finished brew was described by coffee experts as having aroma and flavor, acidity characteristics of African coffees. Also, better fruit notes were described with using the dry vs the liquid fermentation outputs in the formula. Similarly, formula containing dry carob fermented output added a ‘blueberry-like aroma’ to the product.

TABLE 6

| | V3.0 + 20% | V3.0 + 20% | V4.13 + 10% | V6.6 + Flavors + |
|---|---|---|---|---|
| | Coffee pulp | Coffee pulp | Coffee pulp | 4% Carob |
| | (Pichia spp) | (Torulaspora spp) | (Pichia spp.) | (Pichia spp. ) |
| Aroma | Fruity, veggie, | Fruity-caramelize | Tropical fruit | closer to Stumpton |
| | balanced, | notes. More than | aromas (same as | in aroma, acidity, |
| | chocolate, plant | Pichia (this time) | flavor) | sweetness |
| | bitterness; most | | | |
| | similar to | | | |
| | specialty coffee | | | |
| Flavor | It's fruity, more | “Too sour, | “Candied | “Rich milk |
| | watery; | kombucha, | Grapefruit, | chocolate, almost |
| | | fermented, old | papaya, kiwi, lot | like choc milk, some |
| | | peach baby food; | of fruit, complex | bitter elements, |
| | | nice acidity, nutty, | richness and more | agave syrup, |
| | | chocolate, | dense (dark | complex sweetness, |
| | | fruitiness, acidity is | chocolate), good | juicy, grape soda, |
| | | too much; | acidity similar to | like sweet tea, not a |
| | | complex, smooth, | Ethiopian/Kenyan | ton of flavor notes, |
| | | creamy, clean a bit | coffees” | just an enjoyable |
| | | astringent. mouth | | drink; similar acidity |
| | | drying, bitter, | | upfront, not as |
| | | good, smooth” | | punchy that fades |
| | | | | quickly, depleting, |
| | | | | some bitter lingering |
| | | | | finish; lemon juice |
| | | | | acidity” |

### Example 6: Roasting Temperature of Sunflower Seeds Affects Aroma of Resulting Brewed Beverage

This example describes the finding that sunflower seeds roasted at different temperatures, when included in otherwise identical plant base formulas, yield brewed coffee substitute beverages with different flavors and aromas. Sunflower seeds were roasted at various temperatures and flavors assessed (Table 7). Plant base formulas and coffee substitute beverages were prepared and tasted as described in Example 1 according to the ingredients described.

TABLE 7

| Ingredient | V4.10 | V4.11 | V6.5 |
|---|---|---|---|
| Chicory + Lentils + Millet malt + | 90.8% w/w | 90.8% w/w | 89.2% w/w |
| Fenugreek seeds + guarana extract + | | | |
| juniper berries + corn malt + tomato | | | |
| flakes + pumpkin seeds + tomato | | | |
| flakes + quinic acid + CGA | | | |
| Sunflower Seeds light roast | 8.1% w/w | 0 | 0 |
| Sunflower Seeds medium roast | [symbol] | 8.1% w/w | 0 |
| Sunflower Seeds dark roast | 0 | 0 | 10.8% w/w |
| Natural coffee + chocolate flavors | 1.1% w/w | 1.1% w/w | 0 |
| Tasting notes | Aroma: | Aroma: some | slightly more |
| | fenugreek, top | burnt aromatic | darker brew than |
| | notes are not as | notes vs. V4.10 | the other; burnt, |
| | strong; Flavor: | (woody); flavor | beef broth, corn; |
| | tastes stale, | is more dark, | still pretty sweet; |
| | oxidized | roasted, and | more neutral |
| | | balanced; slightly | flavor vs |
| | | less acidic than | v6.3.2.3; still |
| | | 4.10; but | gives the |
| | | definitely tilting | roastiness |
| | | more towards | without all the |
| | | coffee . . . Didn't | added flavors; |
| | | work in espresso, | control: woody, |
| | | too bitter, nutty, | carob, nutty; |
| | | medicinal | same sweetness; |
| | | | has more carob |
| | | | flavor |

### Example 7. Inclusion of Natural-Fermented Coffee Pulp in Alternative Coffee Product and its Sensory Enhancement

During wet coffee processing, the pulp (outer layers of the fruit) is removed from the bean. Once the coffee fruits have been collected from the plant, they are washed with water and put in a clean container. After removing floating grains and plant residues, they are transferred to a jute sack to be rolled over by flattening equipment. This process separates beans from the pulp. Coffee pulp contains important nutrients and chemical compounds characteristic of coffee identity and flavor. Herein, a method to include the natural-fermented coffee pulp in the alternative coffee product is described.

Coffee pulp was obtained and dried for 30 minutes at 80 degrees C. Raw undried coffee pulp was used as a control for comparison. Coffee pulp was fermented in sterilized 300 mL Erlenmeyer flasks with distilled water. The system was incubated overnight at room temperature.

After fermentation, liquid and solid phases were separated by centrifugation and subsequent gravity filtration. The solid phase was analyzed in two different conditions: with and without an additional drying process (30 minutes at 80 degrees C.) after separation.

The liquid and solid phases from the fermentation were evaluated separately for flavor and aroma attributes, both alone, and as adjuvants to coffee substitute beverages prepared from steeping a mixture of plant based ingredients with hot water and the French press method. When the solid phase of fermentation was included in the coffee substitute beverage, the solid phase was supplemented in the mixture of plant based ingredients at 3-5% w/w and brewed as described above. When the liquid phase of fermentation was included in the coffee substitute beverage, the liquid phase was added to the plant based base formula by pipetting at 0.5-1.25% v/w, allowed to rest for 15 minutes, and coffee substitute beverage was prepared as described above.

Liquid and solid phases of fermentation experiments and brewed coffee substitute beverages were evaluated by a panel of trained taste testers. Panelists were asked to evaluate each sample in categories including but not limited to: aroma, flavor, aftertaste, acidity, mouthfeel, and similarity to brewed coffee. Each category was quantified on a scale from 1-10 with 1=dislike extremely/extremely dissimilar to brewed coffee to 10=like extremely/extremely similar to brewed coffee. Panelists also recorded qualitative impressions for each sample, when appropriate, with e.g. descriptors indicating similarity to other food items; floral character; fruity character; chocolate character; sweetness, nuttiness, grain & cereal character; roast character; spice character; savoriness; vegetal, earthy, and/or herbal character; etc.

The sensory analysis of the coffee substitute beverage supplemented with natural-fermented coffee pulp showed the following results as shown in Table 8. The aroma and flavor of Sample 5 were undoubtedly enhanced by addition of the solid phase of a dried fermentation pulp.

TABLE 8
Sensory evaluation of different natural-fermented coffee pulp products in a
coffee substitute beverage:

| | | Dried before | Dried after | | |
|---|---|---|---|---|---|
| Sample | Phase | fermentation | fermentation | Aroma | Flavor |
| 1 | Liquid | No | No | Pretty bad. Too | Stale, ripped, |
| | | | | stale, too ripped, | veggie. |
| | | | | too veggie. | |
| 2 | Liquid | Yes | No | More floral notes | The pulp balanced |
| | | | | than control. | the malty notes. |
| | | | | Intense roasted | There's still a stale |
| | | | | notes.. | note. |
| 3 | Solid | No | No | The pulp | It has a coffee-like |
| | | | | diminished the | note but it's still |
| | | | | stale aroma note a | too veggie. |
| | | | | lot. Still stale. | |
| 4 | Solid | Yes | No | It's too roasted. | It has even more |
| | | | | | sweet, roasted and |
| | | | | | bitter notes than |
| | | | | | coffee. The coffee- |
| | | | | | like note is there. |
| 5 | Solid | No | Yes | There's a clear | It's flavor has a |
| | | | | coffee-like note. | particular coffee |
| | | | | It's less roasted. | bitterness. Almost |
| | | | | Good sweet. It has | not stale. |
| | | | | extra floral and | |
| | | | | chocolate aroma | |
| | | | | notes than control. | |
| 6 | Liquid | No | No | Roasted, medium | Medium roast and |
| (Control) | | | | sourness, barley. | bitterness. Pretty |
| | | | | | malty. |

### Example 8. Fermentation of De-Pitted Coffee Cherry Fruits with Microbial Strains Yields Beverage with Coffee-Like Flavors

This example describes the use of starter cultures for flavor enhancement of a coffee substitute beverage. The strains that are part of these starter cultures are characterized by bringing positive flavor and aroma compounds to the beverage. Therefore, different coffee starter cultures reported in the literature were used as inoculums in coffee pulp fermentations, and the resulting flavor impact was later tasted with the coffee substitute beverage.

Seven bacteria and yeast strains were obtained and grown in basic YPD for 4 days at 27 degrees C. The cultures were pelletized grown in the fermentation media Fermentation was carried out for 48 hours at a constant temperature of 30 degrees C. without shaking. After fermentation, the fermented de-pitted coffee cherry fruit was taken out from the fermented liquid and dried at 65 degrees C. for 1.5 hours.

The solid phase of fermentation products were isolated, included in a mixture of plant based ingredients, coffee substitute beverages prepared, and sensory evaluations conducted as described in Example 1, with the following modifications. The fermentation output was ground to a coarse texture, weighed at 10-20% of the formula and added to the rest of the base formula ingredients, brewed at 1:17 ratio with water at 203 degrees F. using a French press to derive the coffee substitute beverage.

The alternative coffee products prepared from these fermented cherries had various flavors and aromas, including fruity, caramel, herbal, and high acidity. Therefore, Table 9 shows the overall quality enhancement of the final product by the coffee starter cultures fermentation.

TABLE 9
Yeast strains used in fermentation of de-pitted coffee cherry fruits

| Strains | Aroma | flavor |
|---|---|---|
| Pichia fermentans | fruity | grape |
| | | fig |
| | | dark fruits |
| Torulaspora delbrueckii | sweet | bitter, fruity, fermented |
| Saccharomyces cerevisiae | beer like | malty notes, sweet, |
| | | fermented |
| Lactobacillus plantarum | sweet, | base flavor, muy bitter |
| | roasted | |
| Lactococcus lactis | tart | tart, citric |
| | | acidic |
| Defined poly culture (Pichia | Off notes | Off notes |
| fermentans, Saccharomyces | | |
| cerevisiae and Torulaspora | | |
| delbrueck) | | |
| Rhizopus oligosporus | Off notes | Off notes |
| Coffee pulp (control) | Black tea | Dry |
| | like | sweet |

Include the flavors and/or aromas that are not part of the coffee flavor wheel and that are commonly considered as negative notes in coffee drinks.

### Example 9. Addition of Different Monosaccharide, Disaccharides, Oligosaccharides and Mixtures Thereof to De-Pitted Coffee Cherry Fermentation and its Sensory Effects on Coffee Substitute Beverage

During fermentation, the addition of different sugars leads to distinct chemical products, as a result of microbial sugar metabolism. Inventors hypothesized that these fermentation by-products would increase complexity of aroma and flavor when added to coffee substitute beverages. Therefore, different sugars were tested in the fermentation system described in Example 8 to evaluate how they would affect the sensory perception of the coffee substitute beverage.

We formulated a synthetic sugar-containing plant-based medium consisting of dried coffee pulp (powdered) and 1.5% either fructose, glucose, xylose, or malt extract dissolved in water. Fermentation was performed as described in Example 8, with the following modifications.

Four bacteria and yeast strains were obtained and grown in basic YPD media for 4 days at 27 degrees C. The cultures, pelletized and resuspended in water to obtain a starter inoculum. The starter inoculum was added to the synthetic sugar-containing plant-based medium described above (Table 10). For comparison, the negative control condition did not receive microbial inoculum.

Fermentations were conducted for 48 hours at temperatures ranging from 28 degrees C. to 30 degrees C. The liquid phase of fermentation products was isolated, included in a mixture of plant based ingredients, coffee substitute beverages prepared, and sensory evaluations conducted as described in Example 7.

TABLE 10
Sensory characterization of coffee pulp fermentations
supplemented with sugars.

| Strains | Aroma | flavor |
|---|---|---|
| Pichia fermentans | Smokey alcohol | Base, smoke |
| | veggie savory | |
| Torulaspora | Oily, fatty, | Off notes |
| delbrueckii | caramellic | |
| Saccharomyces | Off notes | Off notes |
| cerevisiae | | |
| Lactobacillus | Malt | Malty, base, |
| plantarum | | non alcoholic |
| | | beer, acidic |
| Pichia fermentans, | Off notes | Off notes |
| Torulaspora | | |
| delbrueckii and | | |
| Saccharomyces | | |
| cerevisiae | | |
| Control | n/a | n/a |

### Example 10. Fenugreek Enhances Fermentation Products by Increasing Microbial Growth and Allowing Deposition of Flavor Components on a Solid Substrate

Fenugreek is characterized by its healthful properties, such as being rich in nutrients, antioxidants and other bioactive compounds. We investigated fenugreek as a fermentable source to expand savory aroma and flavors.

Fermentations were performed as described in Example 8 using strains listed in Table 11. These starter inoculums were added to the fermentation substrate containing fenugreek seeds suspended in water. For comparison, the negative control condition did not receive microbial inoculum. Fermentations were conducted for 48 hours at temperatures ranging from 28 degrees C. to 30 degrees C. The fermented fenugreek was then dried at 65 degrees C. for 1-2 hours until obtaining a solid product with a moisture content of <10% (w/w). The solid phase of fermentation products were isolated, included in a mixture of plant based ingredients, coffee substitute beverages prepared, and sensory evaluations conducted as described in Example 7.

Taste testers noted significant differences and positive flavor attributes in all of the conditions tested.

TABLE 11
Sensory evaluation of fermented fenugreek
in a coffee substitute beverage

| Strains | Aroma | Flavor | State |
|---|---|---|---|
| Pichia | Sweet- | Sweet-delicate | solid |
| fermentans | delicate | nippy | |
| Torulaspora | Herby, | Mellow- | solid |
| delbrueckii | spicy | delicate | |
| Saccharomyces | Fruity- | Sour-tart | solid |
| cerevisiae | citrus | Bitter | |
| Control | Dry, | Spicy, sweet, | solid |
| | spicy | nutty, burned | |
| | | brown sugar | |

### Example 11. 80% Carob and 20% Dried Coffee Cherries Enhance Fermentation Products by Increasing Microbial Growth and Producing a Variety of Aroma and Flavors in Both Solid and Liquid Phases

The fermentation experiments were conducted as described in Example 8. The fermentation media was prepared using finely ground carob, ground de-pitted coffee cherry suspended in water. The starter inoculum to the media. Fermentation was carried out for 48 hours at a constant temperature of 30 degrees C. For comparison, the negative control condition did not receive microbial inoculum.

The solid and liquid phases of fermentation products were isolated, included in mixture of plant based ingredients, coffee substitute beverages prepared, and sensory evaluations conducted as described in Example 7, with the following modifications: after 48 hours of fermentation, the fermented de-pitted coffee cherry fruit was taken out from the fermented liquid, and dried to yield a solid product with a moisture content of less than 10% w/w.

As the fermentation progressed, microbial biomass increased, gas evolution was observed, and the broth developed characteristic aromas.

The results demonstrated that the combination of carob and de-pitted coffee cherry fermented by different yeast strains can yield a variety of flavors and aroma. Positive flavor notes that were observed in the liquid include fruity (e.g. prune, lemon, berry, and grape), sour, and sweet, whereas positive flavors that were noted in the dried solids were fruity (lemon, cranberry) and sweetness (see Table 12). Observed positive aroma notes in the fermented liquid include fruity (e.g. prune, fig, grape, and cherry) and tea-like; additionally, positive aroma compounds such as peach, cherry, and sweetness were noted in the aroma of the dried fermented solids (see Table 12).

TABLE 12
Sensory, brix and pH evaluation of fermented carob and
coffee cherries medium with a variety of yeasts.

| | Aroma | Flavor | Aroma & | Flavor |
|---|---|---|---|---|
| Strains | (liquid) | (liquid) | (solid) | (solid) |
| Pichia | Prune | Sour, | Fermented | Sweet |
| fermentans | figs | prune | peach | Watery |
| | | sweetness | | Lemon |
| | | | | Ginger tea |
| Torulaspora | Off | Dark | n/a | n/a |
| delbrueckii | notes | fruity | | |
| Candida | Off | Strong | n/a | Low flavor |
| parapsilosis | notes | tea, sweet | | |
| | | tea, | | |
| | | lemon, | | |
| | | green tea | | |
| Saccharomyces | Low, | Intensely | Sweet | watery |
| cerevisiae | grape, | bitter | fermented | |
| | cherry | Fermented | | |
| | soda | Pre-made | | |
| | | beer | | |
| | | yeasty | | |
| Pichia kluyveri | Grape | Grape | Peach | Cranberry |
| | sweet | Sweet | cherry | Nice |
| | | Blueberry | | acidity at |
| | | sour patch | | the end |
| | | berries- | | |
| | | like | | |
| Control (no | Herbal | Very | n/a | n/a |
| fermentation) | and tea | sweet | | |
| | like | | | |

### Example 12. Carob and Amended Organic Compounds as Precursors Enhances Pichia and Torulaspora Fermentation Products by Increasing Microbial Growth and Allowing Deposition of Flavor Components on Solid Substrate

There are common but also unique fermentation precursors in the coffee fruit matrix that contribute to the flavor complexity of coffee. Yeast metabolism triggers the hydrolysis of macromolecules yielding reducing sugars, amino acids and chlorogenic acids, which are important precursors of aroma. We inspected the potential for such precursor compounds to affect fermentation.

Fermentations were performed as described in Example 11, with the following modifications. The fermentation media was prepared using finely ground carob suspended in sterile water. Chemical precursors were added: either 300 mg caffeine or 81.2 mg caffeic acid. As a negative control, no chemical precursors were added. The starter inoculum of each yeast (Table 13) was added to media and fermentation was carried out for 48 hours at a constant temperature of 30 degrees C. without shaking. The solid and liquid phases of fermentation products were isolated, included in mixture of plant based ingredients, coffee substitute beverages prepared, and sensory evaluations conducted as described in Example 7, with the following modifications: after 48 hours of fermentation, the fermented carob was taken out from and dried to yield a solid product with a moisture content of less than 10% w/w.

As the fermentation progressed, microbial biomass increased, gas evolution was observed, and the broth developed characteristic aromas.

The results of this experiment demonstrated that the combination of carob and precursor can yield a variety of aroma and flavors that are characteristic of coffee. For example, when caffeine was added, taste testers noticed particular flavors such as tea rose, apple, apricot, lemon and aromas such as fruity, nutty, woody and herbal.

TABLE 13
Sensory characterization of carob ferments
supplemented with precursors.

| | Fermentable | | |
|---|---|---|---|
| | substrate + | Aroma | Flavor |
| Strains | precursor | (liquid) | (liquid) |
| Pichia | caffeine | Fruity | Tea like, |
| fermentans | | herbal | dark fruit |
| Torulaspora | caffeine | Berry like | Tea rose |
| delbrueckii | | flowery | |
| Saccharomyces | caffeine | Nutty, | Fermented, |
| cerevisiae | | woody, | mellow, |
| | | bready | acidic |
| Pichia | Caffeic acid | Berry like | Apple |
| fermentans | | | apricot |
| Torulaspora | Caffeic acid | citrus | lemon |
| delbrueckii | | | |
| Saccharomyces | Caffeic acid | Nutty, | Fermented, |
| cerevisiae | | woody, | acidic |
| | | bready | |
| Control | No precursors | Herbal and | sweet |
| | added | tea like | |

### Example 13. Coffee Pulp Fermented with Lactobacillus plantarum Yielded High Acidity in the Liquid Phase

Lactic acid is an important metabolite associated with high acidity in fermented products such as coffee. The objective of this experiment was to modify the fermentation process to increase the acidity of the final coffee substitute beverage. pH was monitored, with pH values below 4.5 indicating the end of the fermentation process.

Lactobacillus plantarum was reactivated in LB (Luria broth) at 28 degrees C. during 24 hours. The fermentation media was prepared using dried coffee pulp or finely ground carob in sterile water. The starter inoculum was added to the media. Fermentation was carried out for 48 hours at a constant temperature of 30 degrees C. The solid and liquid phases of fermentation products were isolated, included in mixture of plant based ingredients, coffee substitute beverages prepared, and sensory evaluations conducted as described in Example 7, with the following modifications: after 48 hours of fermentation, the fermented de-pitted coffee cherry fruit or fermented carob was taken out from the fermented liquid and dried to yield a solid product with a moisture content of less than 10% w/w.

The results of this experiment demonstrated that the addition of Lactobacillus plantarum reduced the pH and increased the acidity of the samples yielding sour, bitter and citrus notes (Table 14).

TABLE 14
Sensory evaluation of acidified samples by Lactobacillus species

| | Fermentable | Aroma | Flavor |
|---|---|---|---|
| Strains | substrate | (liquid) | (liquid) |
| Lactobacillus | de-pitted | Nutty, | Sour |
| plantarum | coffee cherry | amine, | Bitter |
| | | woody, | High |
| | | bready and | acidity |
| | | vegetable- | |
| | | like | |
| Lactobacillus | carob | Waxy | Citrus, |
| plantarum | | | orange, |
| | | | lemon |

### Example 14. A Method for Drying Fermentation Solids for Incorporation in Hot Brew Coffee Substitute Beverage Product

A method of drying fermentation solids is described. Once the fermentation is completed, the fermented solids (e.g. carob, de-pitted coffee cherry fruits) are transferred to blotting paper and are dried, leaving no fermentation liquid. Dried solids are transferred to a Dehydrator Non Stick Mesh Screen and allowed to dry at 65 degrees C. to yield a solid product with a moisture content of less than 10% w/w.

### Example 15. Defined Fermentative Microorganisms are Detectable in Final Product Via DNA Extraction, Polymerase Chain Reaction and Sanger Sequencing

A method of detecting organisms used in the production of the invention is described.

The dry solid product described in this invention contains DNA molecules derived from fermentative organisms described above. These DNA molecules may be detected using polymerase chain reaction (PCR) and Sanger sequencing of the PCR amplicon.

DNA is extracted from the dry solid product using the Zymo Research Plant/Fungal DNA extraction kit. Briefly, the sample is homogenized and transferred to a 2 ml screw-top vial containing a mixture of 0.5 mm and 0.1 mm zirconium beads and 500 ul of DNA extraction buffer. After bead beating, the sample is centrifuged and the supernatant transferred to spin columns for ethanol wash and elution into TE buffer.

PCR is performed using Taq polymerase and standard methods. Amplicons are analyzed by standard DNA gel electrophoresis techniques. Sanger sequencing is performed to verify the identity of the fermentative microorganism.

### Example 16. Traditional Cold Steeping Method of Making Cold Brew Coffee Substitute Beverage

Cold brew coffee substitute beverages, referred to here-after as “cold brew” or “cold brew beverages,” were made using a traditional cold steeping method. A mixture of dry plant-based ingredients (the “base formula”) containing roasted or unroasted whole grains, seeds, pulses and root was ground using the Baratza Encore coffee grinder at its coarsest setting1. Working solutions of pure chemical compounds and natural flavors were added to the dry formula and allowed to absorb for a minimum of 15 minutes. The ingredients were transferred to a mason jar, and a 1:5 ratio of filtered water at 22 degrees C. was added. The grounds were stirred gently with the water and allowed to steep for 0.5-18 hours at 4 degrees C. After 18 hours, the grounds were filtered through 10 micron to 115 microns mesh. The filtered output was diluted 1:1 using cold filtered water and refrigerated again for 2 hours before tasting. The control coffee for comparison was a Brazilian La Colombe canned drink.

### Example 17. Fast Vacuum Based Method of Making Cold Brew Coffee Substitute Beverage

This example describes the production of cold brew beverages using a FrankOne with VacTec cold brew system. The base formula containing roasted or unroasted whole grains, seeds, pulses and root was ground at the coarsest setting on the Cuisinart grinder. Working solutions of pure chemical compounds and natural flavors were added to the dry formula and allowed to absorb for a minimum of 15 minutes. The brewing system was set up with the brewer tightly fixed to the glass carafe unit. The ingredients were transferred to the brewer's shallow area, and a 1:11.33 ratio of filtered water at 22 degrees C. was added. The lid was put back on and the contents allowed to extract for 2 minutes. After a quick stir, the extraction was allowed to continue for a total of 4 minutes, before the brewer's button was pressed to extract the brew using vacuum. During the process, the grounds were stirred gently and the cold brew was transferred to a clean container. The cold brew beverage was refrigerated for at least 24 hours before tasting for aroma, flavor and other attributes.

### Example 18. Base Formulas Using Roasted Carob with Fermented Outputs Improved the Cocoa and Sweet Roasted Flavor in the Cold Brew Beverage

Base formulas and cold brew coffee substitute beverages were prepared as described in Example 17. Roasted carob was brewed separately using the FrankOne method (as in Example 17) and 10% w/w of roasted carob added to the formula allowed the cold brew to have the “perfect sweetness, along with those sweet-roasted, chocolate notes and strong flavor characteristics of cold brew” like our Benchmark-La Colombe Brazilian Cold Brew. Tasters described the flavor with the roasted carob as “burnt marshmallow, chocolate, sweet-burnt”

### Example 19. Addition of Natural Flavor Combinations with a Plant Ingredient Base Formula+Fermented Outputs Improved the Aroma Attributes of the Cold Brew Coffee Substitute

Several commercial natural flavors were tested as adjuvants to the base formula for delivering the right aroma profile of cold brew substitute beverage and also to mask undesired flavors stemming from the base ingredients. Table 15 lists the different chemical compounds blended to create a flavor blend and 10.2 shows a compilation of he aroma and flavor of cold brew beverages prepared as described in Example 16 following the corresponding addition of these flavor combinations.

Some of the flavor combinations increased the aroma and increased similarity to the benchmark La Colombe cold brew, whose aroma was described by a coffee expert as “Maple”, “molasses”, “sweet smokiness”, and “green pepper”.

TABLE 15
Flavor combination using pure chemical compounds

| | Flavor compounds |
|---|---|
| CC | Guaiacol + furanone + 2-furfurylthiol + |
| | Beta-damascenone + Phenylacetaldehyde |
| CC10 | Guaiacol + furanone + 2-furfurylthiol + |
| | 3-mercapto-3-methylbutylformate + |
| | 4-ethylguaiacol + 4-vinylguaiacol + Beta- |
| | damascenone + Phenylacetaldehyde + |
| | 2,3-butanedione |

Furanone=4-hydroxy-2,5-dimethyl-3(2H)-furanone

TABLE 16
Combination of natural flavors and Compound coffee's flavor combination

| | Flavor combination | | |
|---|---|---|---|
| Formula | (percentages w/w) | Brewing method | Aroma/Flavor |
| v3.0 | 1% Natural flavors | Traditional, 18 hours | Aroma: Maple, Sweet; |
| | (coffee, maple) | | Flavor: chocolate, caramel, |
| | | | peanut, sunflower, spicy |
| v3.5F + 10% | F1.0: 0.88% Natural | Traditional, 18 hours | roasted, chocolate, very |
| Coffee pulp- | flavors (coffee, | | nutty |
| Pichia + F1.0 | chocolate) + 11.8% CC | | |
| V3.8.1 +10% | F1.0: 0.88% Natural | FrankOne | more chocolate notes, |
| Coffee pulp- | flavors (coffee, | | sulfur; The aroma was very |
| Pichia + F1.0 | chocolate) + 11.8% CC | | faint. A fruity sweetness |
| | | | which then faded into a |
| | | | more nutty chocolate or |
| | | | almost like opening a bag |
| | | | of chocolate covered |
| | | | almonds. |
| V3.9 + 10% | F1.0: 0.88% Natural | FrankOne | Furanone, Brownie, best; |
| Coffee pulp- | flavors (coffee, | | Strong Honey, burnt flavor |
| Pichia + F1.0 | chocolate) + 11.8% CC | | |
| V4.11 +10% | F1.0: 0.88% Natural | FrankOne | Aroma is more caramel/ |
| Coffee pulp- | flavors (coffee, | | chocolate; better richer |
| Pichia + F1.0 | chocolate) + 11.8% CC | | flavor than 4.13 |
| | | | “Hop water-brings all the |
| | | | elements of beer--without |
| | | | alcohol-reminiscent of |
| | | | coffee and |
| | | | Refreshing, a little malty |
| | | | (barley almost), almost no |
| | | | acidity and fruit; Little |
| | | | more chocolate, richer, |
| | | | more intense, light and |
| | | | delicate; More buckwheat, |
| | | | green tea, cereals, can |
| | | | drink a ton of it” |
| V1.5.2 | F3.0: 1% Natural | Traditional, 18 hours | “Really nice chocolate |
| | flavors (Chocolate + | | aroma”, “smells like |
| | Coffee) + 1.42% | | caramel”, “super strong |
| | Compound flavor C10 | | vanilla”, “sweet cracker |
| | | | like notes” |
| V1.6.2 | F3.0: 1% Natural | Traditional, 18 hours | Black Cherry, Root Beer, |
| | flavors (Chocolate + | | Cola, Dark Chocolate, nice |
| | Coffee) + 1.42% | | |
| | Compound flavor C10 | | |
| V1.6.2 | F4.0: 1% Natural | Traditional, 18 hours | Chocolate milk, strawberry |
| | flavors (Fruity + | | fresh, strawberry licorice, |
| | Chocolate) + 1.63% | | artificial strawberry, sweet |
| | Compound Flavor C10 | | acidity to nose, fruitiness |

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

In general, any of the apparatuses and methods described herein should be understood to be inclusive, but all or a sub-set of the components and/or steps may alternatively be exclusive, and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A composition configured to form a coffee-like beverage, the composition comprising: a mixture of a plant-based formulation and a fermented fermentation substrate, wherein the plant-based formulation is unfermented; further wherein the fermented substrate is included at between about 1% and 80% of the weight of the plant-based formulation, and wherein the fermented fermentation substrate comprises one or more of: fermented de-pitted coffee cherry fruits, fermented coffee pulp, fermented carob, fermented oats, fermented oat malt, fermented malt extract, fermented pomegranate pomace or its extract, fermented date seeds, fermented chicory, fermented figs, fermented sunflower seeds, fermented citrus fruit peel, and fermented fenugreek, further wherein the fermented fermentation substrate comprises one or both of a fermentation solid and/or a fermentation liquid extract of the fermented fermentation substrate.

2. The composition of claim 1, wherein the plant-based formulation comprises one or more of: between about 5%-50% w/w ground chicory, between about 5%-60% w/w date seeds, between about 0.1%-25% w/w grape seeds or grape seed extract, and between about 0.01-0.62% caffeine.

3. The composition of claim 2, wherein the plant-based formulation comprises one or more of:
between about 5%-25% w/w ground sunflower seeds,
between about 5%-30% w/w ground lentil,
between about 2%-20% w/w malt or malt extract,
between about 1%-20% cinchona bark,
between about 0.1%-5% dandelion,
between about 0.1%-5% wormwood,
between about 3.5%-5% w/w of guarana extract,
between about 0.1%-25% w/w carob kibbles or pods or grounds or extract, and/or
between about 0.05%-3% organic acids including but not limited to chlorogenic acid (CGA), citric, malic, tartaric, fumaric, valeric, butyric, formic and propionic acids.

4. The composition of claim 1, wherein the fermented fermentation substrate comprises residual fermentation microbial remains of one or more of: Pichia fermentans, Pichia guilliermondii, Torulaspora delbrueckii, Saccharomyces cerevisiae, Lactobacillus plantarum, Lactococcus lactis, Rhizopus oligosporus, Candida parapsilosis, and Pichia kluyveri.

5. The composition of claim 1, wherein the fermented fermentation substrate comprises one or more of: fermented de-pitted coffee cherry fruits, fermented coffee cherry pulp, fermented carob, fermented pomegranate pomace or pomegranate pomace extract, fermented date seeds, fermented sunflower seeds, fermented chicory, fermented figs, fermented citrus fruit peel, fermented malt or malt extract, and fermented fenugreek which has been fermented with one or more of: Pichia fermentans, Pichia guilliermondii, Torulaspora delbrueckii, Saccharomyces cerevisiae, Lactobacillus plantarum, Lactococcus lactis, Rhizopus oligosporus, Candida parapsilosis, Pichia kluyveri, Leuconostoc mesenteroides, Lactobacillus paracasei, Lactobacillus acidophilus, Lactobacillus bulgaricus, Lactobacillus helveticus, Acetobacter spp., Gluconobacter spp., and Lachancea thermotolerans.

6. The composition of claim 1, wherein the fermented fermentation substrate comprises a fermentation liquid extract comprising water-soluble metabolites of the fermented fermentation substrate.

7. The composition of claim 1, wherein the fermented fermentation substrate comprises both the fermentation solid and the fermentation liquid extract of the fermented fermentation substrate.

8. The composition of claim 3, wherein the chlorogenic acid is recombinant chlorogenic acid.

9. The composition of claim 3, wherein the malt extract is one or more of rice malt, oat malt, barley malt, corn malt, millet malt and coffee malt.

10. The composition of claim 3, wherein the ground sunflower is roasted.

11. The composition of claim 3, wherein the carob is roasted.

12. The composition of claim 2, wherein the plant-based formulation further comprises between about 6%-16% w/w of ground roasted fenugreek.

13. The composition of claim 2, wherein the plant-based formulation further comprising one or more of: between about 6%-16% w/w of ground fenugreek, between about 0.2%-1% w/w quinic acid, between about 4%-8% w/w of ground tomato flakes, between about 5%-11% w/w ground pumpkin seed; between about 0.5%-2% w/w yeast; and between about 0.1%-0.5% w/w ground juniper berries.

14. The composition of claim 2, wherein the plant-based formulation further comprising one or more of ground, powdered or dehydrated: acorn, asparagus seed, barley, buckwheat, black eyed peas, burdock, Cabernet Sauvignon wine, flour, caffeine, carrots, chana dal chickpeas, chocolate, cocoa, cacao, cinnamon, citric acid, coriander seeds, corn, cranberry seeds, dandelion root, dried tomato flakes, fenugreek, figs, rice, grape seed extract, green split peas, guarana extract, juniper berries, lentils, mango, mesquite, caramel millet, chocolate pale malt, coffee malt, Reishi mushrooms, oats, okra, orange peel, mushrooms, orange peel, pale corn, pumpkin seeds, quinic acid, ramon seeds, raspberry seeds, rye, Saborizante Artificial, Sacha inchi seeds, soybeans, strawberry Seeds, sugar beets, tamarind seeds, turmeric, and yeast.

15. The composition of claim 1, wherein the plant-based formulation has a median particle size in the range of 200-1500 micrometers.

16. The composition of claim 1, wherein said plant-based formulation has a median particle size in the range of 200-1500 micrometers and at least 85% by weight of said plant-based formulation have a particle size in the range of 200-1000 micrometers.

17. The composition of claim 1, wherein the plant-based formulation comprises at least 5% by weight of melanoidins.

18. The composition of claim 1, wherein the plant-based formulation comprises chlorogenic acid at a concentration of at least 0.9% by weight.

19. The composition of claim 1, wherein the composition is sealed within one or more of: a foil package, a water-permeable bag, ajar or a canister.

20. The composition of claim 1, further comprising between about 0.1 and 3% w/w of one or more of: Guaiacol, 4-ethylguaiacol, 4-vinylguaiacol, 3-mercapto-3-methylbutylformate, 2-furfurylthiol, Furaneol, 2,3-pentanedione, 3-methylbutanoic acid, 3-methybutanal, P-cresol, 2,3-dimethylpyrazine, 2-methylbutanal, 2-methylpropanal, Maltol, Phenylacetaldehyde, Phenylacetic acid, Linalool, Damascenone, 2-ethyl-3,5 dimethyl pyrazine, 2 ethyl 5(6) methyl pyrazine, 2-acetyl-1-methylpyrrole, EHMF (5-Ethyl-3-hydroxy-4-methyl-2(5H)-furanone), 2-isolbutyl-3-methoxypyrazine, 2-sec-butyl-3-methoxypyrazine, 2,3-diethyl-5-methylpyrazine, pyridine, 3-(methylthio)butanal, 2,5-dimethyl pyrazine, 2 methyl tetrahydrofuran-3-one, 2 ethyl 3 methylpyrazine, 2 methylpyrazine and bell pepper pyrazine (3-isolbutyl-2-methoxypyrazine), 1,2-Cyclopentanedione 3-methyl-; 1H-Pyrrole, 1-(2-furanylmethyl)-; 1H-Pyrrole, 1-methyl-; 1H-Pyrrole, 1-pentyl-; 1-Hydroxy-2-butanone; 2(3H)-Furanone, 5-acetyldihydro-; 2(5H)-Furanone; 2-Acetyl-3-methylpyrazine; 2-Acetyl-5-methylfuran; 2-Butenoic acid, 3-methyl-; 2-Cyclopenten-1-one, 3-ethyl-2-hydroxy-; 2-Furanmethanol, propanoate; 2-Hydroxy-3-pentanone; 2-n-Butyl furan; 2-Propanone, 1-hydroxy-; 2-Thiophenemethanol; 3(2H)-Thiophenone, dihydro-2-methyl-; 3-Thiophenecarboxaldehyde; Acetoin; Acetone; Acetylpyrazine; Butyrolactone; Ethanone, 1-(1H-pyrrol-2-yl)-; Ethanone, 1-(1-methyl-1H-pyrrol-2-yl)-; Ethanone, 1-(2-pyridinyl)-; Furan, 2-(2-furanylmethyl)-5-methyl-; Furan, 2,2′-methylenebis-; Furan, 2-[(methylthio)methyl]-; Furan, 2-methyl-; Furan, 4,5-diethyl-2,3-dihydro-2,3-dimethyl-; Propanoic acid; Pyrazine; Pyrazine, 2,6-dimethyl-; Pyrazine, ethyl-; Pyridine, 3-ethyl-; Pyridine, 3-methyl-; Pyrrole; 1H-Pyrrole-2-carboxaldehyde; 1H-Pyrrole-2-carboxaldehyde, 1-methyl-; 2-Butanone, 1-(acetyloxy)-; 2-Furancarboxaldehyde, 5-methyl-; 2-Furanmethanol; 2-Furanmethanol, acetate; 2-Propanone, 1-hydroxy-; Acetaldehyde; Acetoin; Butyrolactone; Ethanone, 1-(2-furanyl)-; Furan, 2-methyl-; Furfural; Pyrazine, 2,6-dimethyl-; Pyrazine, 3-ethyl-2,5-dimethyl-; Pyrazine, ethyl-.

21. A composition configured to form a coffee-like beverage, the composition comprising: a mixture of a plant-based formulation that is unfermented and a fermented fermentation substrate, wherein the plant-based formulation comprises: between about 5%-50% w/w ground chicory, between about 5%-60% w/w date seeds, between about 0.1%-25% w/w grape seeds or grape seed extract, and between about 0.01-0.62% caffeine; further wherein the fermented fermentation substrate is included at between about 1% and 80% of the weight of the plant-based formulation, and wherein the fermented fermentation substrate comprises one or more of: fermented de-pitted coffee cherry fruits, fermented coffee pulp, fermented carob, fermented oats, fermented oat malt, fermented malt extract, fermented pomegranate pomace or its extract, fermented date seeds, fermented chicory, fermented figs, fermented sunflower seeds, fermented citrus fruit peel, and fermented fenugreek, further wherein the fermented substrate comprises one or both of a fermentation solid and/or a fermentation liquid extract of the fermented fermentation substrate and comprises residual fermentation microbial remains of one or more of: Pichia fermentans, Pichia guilliermondii, Torulaspora delbrueckii, Saccharomyces cerevisiae, Lactobacillus plantarum, Lactococcus lactis, Rhizopus oligosporus, Candida parapsilosis, and Pichia kluyveri.

22.-33. (canceled)

34. A method of forming a coffee-like beverage, the method comprising:
preparing an unfermented plant-based formulation by combining roasted and unroasted dry, plant-based ingredients;
fermenting a plant-based fermentation substrate after combining with one or more one or more microorganism strains or a consortium of microorganisms to form a fermented fermentation substrate;
combining the unfermented plant-based formulation with the fermented fermentation substrate comprising one or both of a fermentation solid and/or a fermentation liquid extract of the fermented fermentation substrate so that the fermented fermentation substrate is included at between about 1% and 80% of the weight of the plant-based formulation to form a mixture; and
drying the mixture to form grounds for a coffee substitute beverage or brewing the mixture to form the coffee substitute beverage.

35.-63. (canceled)
